(19) United States
(12) Patent Application Publication
(10) Pub. No.: US 2003/0170576 A1
(43) Pub. Date: Sep. 11, 2003

(54) Heat-developable photosensitive material

(75) Inventor: Kouta Fukui, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/319,600

(22) Filed: Dec. 16, 2002

(30) Foreign Application Priority Data
Dec. 14, 2001 (JP) P.2001-381569

(51) Int. Cl. G03C 1/498

(52) U.S. Cl. 430/618; 430/350

(57) ABSTRACT

A heat-developable photosensitive material comprising a photosensitive silver halide, a non-photosensitive organic silver salt, a reducing agent and a binder contained in one side of a support, wherein chloride ion concentration in the entire layer positioned on the photosensitive silver halide-containing side of the support is 600 ppm or less based on the weight of the organic silver salt, and the heat-developable photosensitive material contains a compound represented by formula (I) defined in the specification.

### FIELD OF THE INVENTION

This invention relates to a heat-developable photosensitive material.

### BACKGROUND OF THE INVENTION

In view of environmental protection and space conservation, great concern has recently been directed toward the reduction of treated wastewater in the field of medical diagnosis films and in the field of photoengraving films. Thus, techniques are in demand regarding heat-developable photosensitive materials as medical diagnosis films and photoengraving films which can be exposed efficiently by a laser image setter or a laser imager and can form clear black images having high resolution and sharpness. According to these heat-developable photosensitive materials, solution system of processing chemicals is not necessary so that a heat-developable treating system which is more simple and does not spoil the environment can be supplied to customers.

Though there are similar requirements in the field of general image forming materials, medical diagnosis images particularly require high image quality having superior sharpness and graininess due to requirement for fine delineation and have a characteristic in that images of cold black tone are preferred from the viewpoint of easy diagnosis.

At present, various hard copy systems making use of pigment and dyestuff, such as ink jet printers and electrophotography, are distributed as general image forming systems, but they are not satisfactory as an output system of medical images.

On the other hand, thermal image forming systems making use of organic silver salts are described, e.g., in U.S. Pat. Nos. 3,152,904 and 3,457,075 and D. Klosterboer “Thermally Processed Silver Systems” (Imaging Processes and Materials, Neblette Eighth Edition, edited by J. Sturge, V. Walworth and A. Shepp, Chapter 9, p. 279, 1989), which are generally called dry silver type heat-developable photosensitive material.

Particularly, the heat-developable photosensitive material generally has a photosensitive layer in which catalytically effective amount of a photo-catalyst (e.g., a silver halide), a reducing agent, a reducible silver salt (e.g., an organic silver salt) and, if desired, a toning agent which controls color tone of silver are dispersed in the matrix of a binder.

The heat-developable photosensitive material forms a black silver image by heating at a high temperature (e.g., 80° C. or more) after image exposure and then effecting an oxidation reduction reaction between the reducible silver salt (functions as an oxidizing agent) and the reducing agent. The oxidation reduction reaction is accelerated by the catalytic action of the silver halide latent image generated by exposure. Accordingly, the black silver image is formed in the exposed region. This is disclosed in many literatures including U.S. Pat. No. 2,910,377 and Japanese Patent Publication No. 4924/1968.

Regarding definition of halide ion concentration in the heat-developable material, EP 0964299A discloses to define halide ion concentration based on a water-soluble protein binder, but this patent is related to a thermosensitive recording material, different from the embodiment of the invention, and does not describe the effect of the invention.

In the field of medical diagnosis images by a laser imager system which uses the heat-developable photosensitive material, the fog density is high in comparison with conventional silver halide photosensitive materials which use processing solutions such as a developing solution, so that its improvement has been desired.

In addition, the dry silver type heat-developable photosensitive material is not sufficient in the preservability of samples after heat development, so that its improvement has been desired.

### SUMMARY OF THE INVENTION

The invention contemplates overcoming these problems involved in the conventional techniques. More specifically, an object of the invention is to provide a heat-developable photosensitive material as a photosensitive material for use in applications such as medical images and photoengraving, which can provide practically sufficient density with low fog and is improved in preservability of samples after heat development.

The inventors have conducted intensive studies with the aim of resolving the problem and found as a result that a desirable heat-developable photosensitive material which exerts expected effects can be produced by using the combination of the invention, thus resulting in the accomplishment of the invention.

That is, the invention is as follows.

(1) A heat-developable photosensitive material comprising a support provided on one side thereof at least (1) a photosensitive layer containing a photosensitive silver halide, (2) a non-photosensitive organic silver salt, (3) a reducing agent and (4) a binder, wherein chloride ion concentration in all layers positioned on the photosensitive layer side of the support is 600 ppm or less based on the weight of the organic silver salt, and the heat-developable photosensitive material contains a compound represented by the following formula (I):

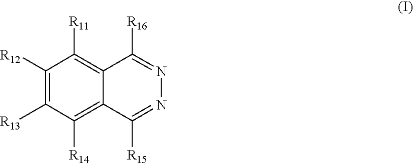

In formula (I), R₁₁, R₁₂, R₁₃, R₁₄, R₁₅ and R₁₆ each independently represent a hydrogen atom or a monovalent substituent group, or R₁₁, R₁₂, R₁₃, R₁₄, R₁₅ and R₁₆ may be combined with each other to form a ring, provided that all of R₁₁ to R₁₆ are not hydrogen atoms.

(2) The heat-developable photosensitive material according to the item (1), wherein the photosensitive layer is one formed by applying an aqueous solution containing polymer latex in an amount of from 60% by weight to 100% by weight based on the amount of a binder of the photosensitive layer and drying.

(3) The heat-developable photosensitive material according to the item (1), wherein the photosensitive layer is one formed by applying an organic solvent solution containing polyvinyl butyral in an amount of from 60% by weight to 100% by weight based on the amount of a binder of the photosensitive layer and drying.

(4) The heat-developable photosensitive material according to the item (2), wherein chloride ion concentration in the polymer latex solution is 100 ppm or less.

(5) The heat-developable photosensitive material according to the item (3), wherein chloride ion concentration in the polyvinyl butyral is 50 ppm or less.

(6) The heat-developable photosensitive material according to any one of the items (1) to (5), wherein a melting point of the compound represented by formula (I) is −20° C. to 130° C.

### DETAILED DESCRIPTION OF THE INVENTION

The invention is described in detail below.

(Description of Organic Silver Salt)

The organic silver salt for use in the invention is a silver salt which is relatively stable against light but forms a silver image when heated to 80° C. or more in the presence of an exposed photo-catalyst (e.g., latent image of a photosensitive silver halide) and a reducing agent. The organic silver salt may be any organic substance which contains a source capable of reducing silver ion.

Such non-sensitive organic silver salts are described, e.g., in Japanese Patent Laid-Open No. 62899/1998 (paragraph numbers 0048 to 0049), European Patent Publication No. 0803764A1 (line 24 on page 18 to line 37 on page 19), European Patent Publication No. 0962812A1, Japanese Patent Laid-Open No. 349591/1999, Japanese Patent Laid-Open No. 2000-7683 and Japanese Patent Laid-Open No. 2000-72711. Silver salts of organic acids, particularly silver salts of long chain aliphatic carboxylic acids (having from 10 to 30, preferably from 15 to 28 carbon atoms) are desirable.

Preferred examples of the organic silver salts include silver behenate, silver arachidate, silver stearate, silver oleate, silver laurate, silver caproate, silver myristate, silver palmitate and mixtures thereof. Among these organic silver salts, according to the invention, it is desirable to use an organic acid silver salt having the silver behenate content of 75% by mol or more.

Shape of the organic silver salt which can be used in the invention is not particularly limited and may be a needle shape, a rod shape, a plate shape or a scale shape, preferably a needle shape or a scale shape, particularly preferably a scale shape.

According to the invention, the scale shape organic silver salt is defined as follows. When an organic silver salt is observed under an electron microscope to approximate the shape of the organic silver salt particle as rectangular solid, and sides of this rectangular solid are defined as a, b and c from the shortest one (c may be the same as b), x is obtained as follows by calculating from the shorter values a and b.

x=b/a

When x is obtained on approximately 200 particles in this manner and their average value is defined x (average), the one satisfying a relationship of x (average)≧1.5 is defined as the scale shape. It is preferably 30≧x (average)≧1.5, more preferably 20≧x (average)>2.0. In this connection, the needle shape means 1≦x (average)<1.5.

In the scale shape particle, a can be regarded as the thickness of a plate shape particle having a plane with the sides b and c as the main plane. The average of a is preferably 0.01 μm or more and 0.23 μm or less, more preferably 0.1 μm or more and 0.20 μm or less. The average of c/b is preferably 1 or more and 6 or less, more preferably 1.05 or more and 4 or less, further preferably 1.1 or more and 3 or less, particularly preferably 1.1 or more and 2 or less.

It is desirable that particle size distribution of the organic silver salt is a monodisperse system. According to the monodisperse system, the percentage value when the standard deviation of respective lengths of the minor axis and major axis is divided by the average value of respective lengths of the minor axis and major axis is preferably 100% or less, more preferably 80% or less, further preferably 50% or less. Regarding the method for measuring shape of organic silver salt, it can be determined from transmission electron microscopic image of organic silver salt dispersion. As another method for measuring monodisperse ability, there is a method for calculating standard deviation of volume weighted average diameter of the organic silver salt, and percentage of the value divided by the volume weighted average diameter (coefficient of variation) is preferably 100% or less, more preferably 80% or less, further preferably 50% or less.

Regarding the measuring method, it can be calculated, e.g., from the particle size (volume weighted average diameter) obtained by applying a laser beam to the organic silver salt dispersed in a liquid and calculating auto-correlation function to periodical change of fluctuation of the scattered light.

Known methods can be applied to the production and dispersion of the organic silver salt to be used in the invention. For example, the methods described, e.g., in Japanese Patent Laid-Open No. 62899/1998, European Patent Publication No. 0803763A1, European Patent Publication No. 0962812A1, Japanese Patent Laid-Open No. 349591/1999, Japanese Patent Laid-Open No. 2000-7683, Japanese Patent Laid-Open No. 2000-72711, Japanese Patent Laid-Open Nos. 348228 to 30/1999, Japanese Patent Laid-Open No. 203413/1999, Japanese Patent Application No. 2000-90093, Japanese Patent Application No. 2000-195621, Japanese Patent Application No. 2000-191226, Japanese Patent Application No. 2000-213813, Japanese Patent Application No. 2000-214155 and Japanese Patent Application No. 2000-191226 can be used as references.

In this connection, since fog is increased and sensitivity is considerably reduced when a photosensitive silver salt is present at the time of the dispersion of organic silver salt, it is desirable that the photosensitive silver salt is not contained substantially at the time of the dispersion. According to the invention, amount of the photosensitive silver salt in an aqueous dispersion solution is 0.1% by mol or less based on 1 mol of the organic silver salt in the solution, and positive addition of the photosensitive silver salt is not carried out.

According to the invention, it is possible to produce a photosensitive material by mixing an organic silver salt aqueous dispersion with a photosensitive silver salt aqueous dispersion. Mixing ratio of the organic silver salt and photosensitive silver salt can be selected in response to the purpose, but ratio of the photosensitive silver salt to the organic silver salt is preferably within the range of from 1 to 30% by mol, more preferably from 3 to 20% by mol, particularly preferably from 5 to 15% by mol. Mixing of two or more organic silver salt aqueous dispersions with two or more photosensitive silver salt aqueous dispersions is a method preferably used for controlling photographic characteristics.

The organic silver salt of the invention can be used in a desired amount, but it is preferably from 0.1 to 5 g/m², more preferably from 1 to 3 g/m², as the amount of silver.

(Description of Reducing Agent)

The heat-developable photosensitive material of the invention contains a reducing agent for the organic silver salt. The reducing agent for the organic silver salt may be an optional substance (preferably an organic substance) which reduces silver ion to metallic silver. Such reducing agents are described in Japanese Patent Laid-Open No. 65021/1999 (paragraph 0043 to 0045) and European Patent Publication No. 0803764A1 (line 34 on page 7 to line 12 on page 18).

According to the invention, reducing agents of bisphenols are desirable as the reducing agent, which are compounds represented by the following formula (R).

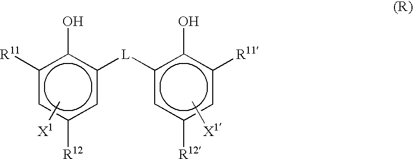

In formula (R), R¹¹ and R^{11′} each independently represent an alkyl group having from 1 to 20 carbon atoms, R¹² and R^{12′} each independently represent a hydrogen atom or a substituent group which can be substituted on the benzene ring, L represents —S— group or a —CHR¹³— group, R¹³ represents hydrogen atom or an alkyl group having from 1 to 20 carbon atoms, and X¹ and X^{1′} each independently represent a hydrogen atom or a group which can be substituted on the benzene ring.

The formula (R) is described in detail.

R¹¹and R^{11′} are each independently a substituted or unsubstituted alkyl group having from 1 to 20 carbon atoms, and though substituent group of the alkyl group is not particularly limited, its preferred examples include aryl group, hydroxy group, alkoxy group, aryloxy group, alkylthio group, arylthio group, acylamino group, sulfonamido group, sulfonyl group, phosphoryl group, acyl group, carbamoyl group, ester group and a halogen atom.

R¹² and R^{12′} are each independently a hydrogen atom or a substituent group which can be substituted on the benzene ring, and X¹ and X^{1′} are also each independently a hydrogen atom or a group which can be substituted on the benzene ring. As the respective groups which can be substituted on the benzene ring, alkyl group, aryl group, halogen atom, alkoxy group and acylamino group can be preferably exemplified.

L represents —S— group or a —CHR¹³-group. R¹³ represents a hydrogen atom or an alkyl group having from 1 to 20 carbon atoms, and the alkyl group may have a substituent group.

Illustrative examples of the unsubstituted alkyl group of R¹³ include methyl group, ethyl group, propyl group, butyl group, heptyl group, undecyl group, isopropyl group, 1-ethylpentyl group and 2,4,4-trimethylpentyl group.

Examples of the substituent group of alkyl group are similar to the substituent groups of R¹¹, which include halogen atom, alkoxy group, alkylthio group, aryloxy group, arylthio group, acylamino group, sulfonamido group, sulfonyl group, phosphoryl group, oxycarbonyl group, carbamoyl group and sulfamoyl group.

Preferred as R¹¹ and R^{11′} are secondary or tertiary alkyl groups having from 3 to 15 carbon atoms, and their illustrative examples include isopropyl group, isobutyl group, t-butyl group, t-amyl group, t-octyl group, cyclohexyl group, cyclopentyl group, 1-methylcyclohexyl group and 1-methylcyclopropyl group.

More preferred as R¹¹ and R^{11′} are tertiary alkyl groups having from 4 to 12 carbon atoms, of which t-butyl group, t-amyl group and 1-methylcyclohexyl group are further preferred and t-butyl group is most preferred.

Preferred as R¹² and R^{12 ′} are alkyl groups having from 1 to 20 carbon atoms, and their illustrative examples include methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferred are methyl group, ethyl group, propyl group, isopropyl group and t-butyl group.

X¹ and X^{1′} are preferably hydrogen atoms, halogen atoms or alkyl groups, and more preferably hydrogen atoms.

L is preferably a —CHR¹³-group.

Preferred as R¹³ is a hydrogen atom or an alkyl group having from 1 to 15 carbon atoms, and methyl group, ethyl group, propyl group, isopropyl group and 2,4,4-trimethylpentyl group are preferred as the alkyl group. Particularly preferred as R¹³ is a hydrogen atom, methyl group, propyl group or isopropyl group.

When R¹³ is a hydrogen atom, R¹² and R^{12′} are preferably alkyl groups having from 2 to 5 carbon atoms, and ethyl group and propyl group are more preferably and ethyl group is most preferable.

When R¹³ is a primary or secondary alkyl group having from 1 to 8 carbon atoms, R¹² and R^{12′} are preferably methyl group. As the primary or secondary alkyl group having from 1 to 8 carbon atoms of R¹³, methyl group, ethyl group, propyl group or isopropyl group is more desirable and methyl group, ethyl group or propyl group is further desirable.

When all of R¹¹, R^{11′}, R¹² and R^{12′} are methyl group, it is desirable that R¹³ is a secondary alkyl group. In that case, isopropyl group, isobutyl group or 1-ethylpentyl group is desirable, and isopropyl group is more desirable, as the secondary alkyl group of R¹³.

Illustrative examples of the reducing agent of the invention including the compounds represented by formula (R) are shown below, though the invention is not limited thereto.

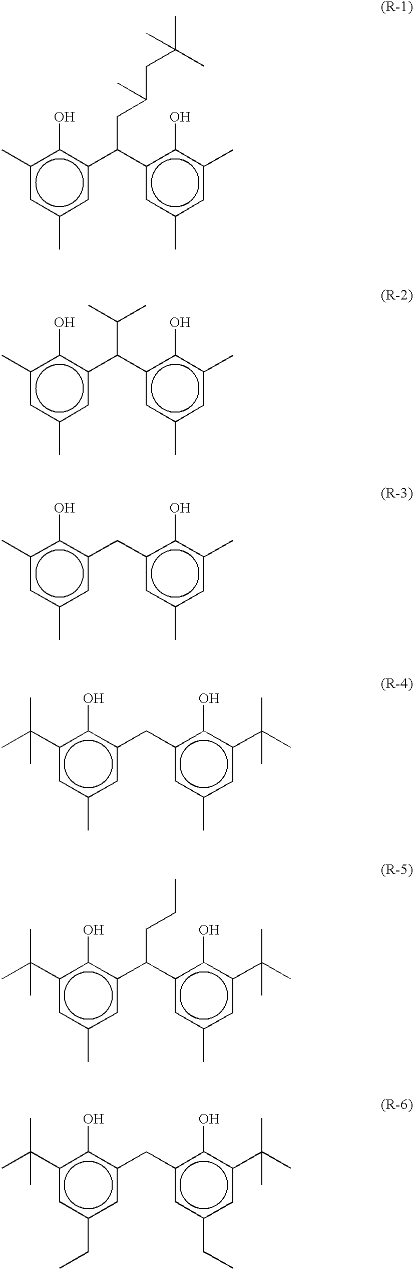

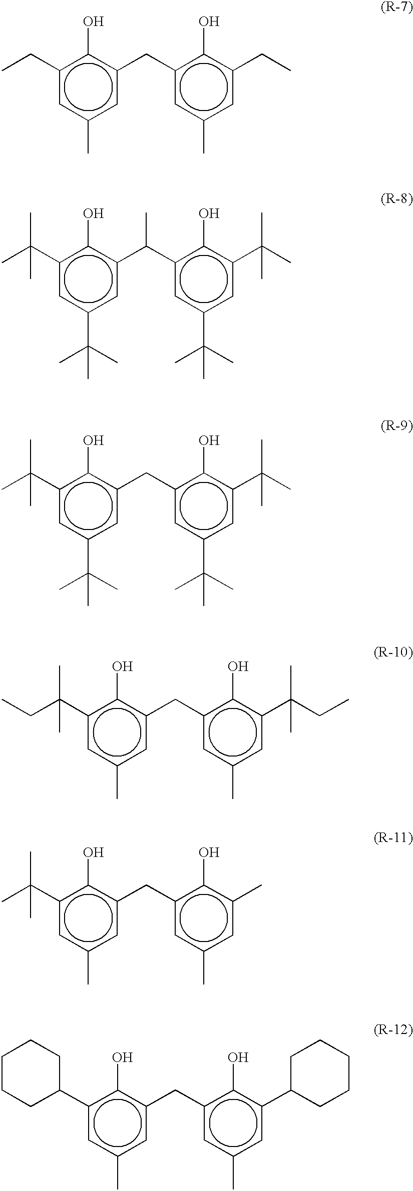

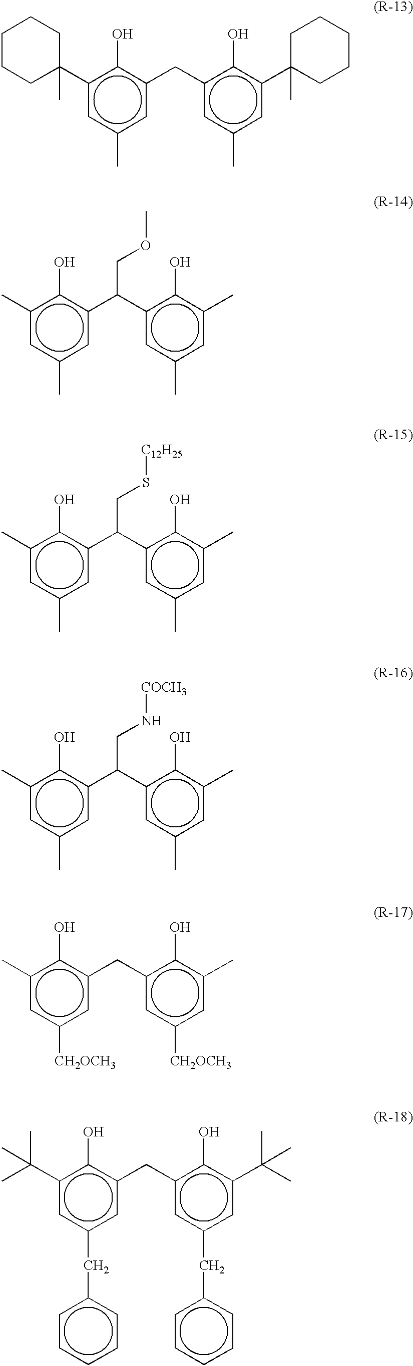

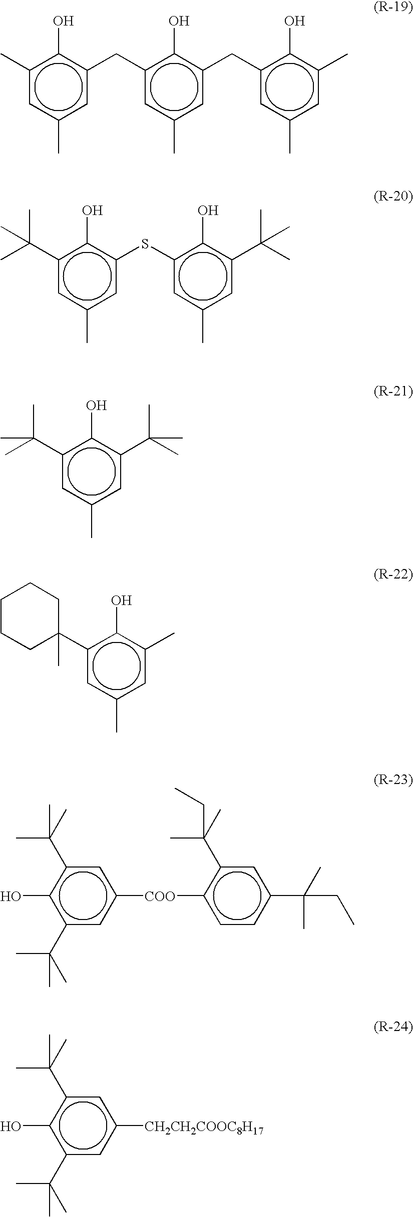

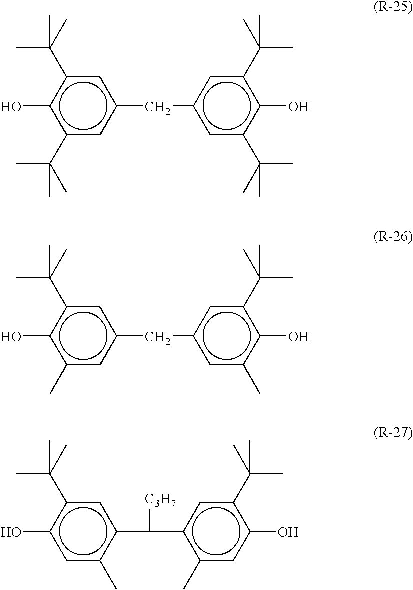

According to the invention, adding amount of the compound represented by formula (R) is preferably from 0.01 to 5.0 g/m², more preferably from 0.1 to 3.0 g/m², and it is desirable to contain it in an amount of from 5 to 50% by mol, more desirably from 10 to 40% by mol, based on 1 mol of silver on the side having an image forming layer.

It is desirable that the compound represented by formula (R) is contained in the image forming layer.

The compound represented by formula (R) may be contained in the photosensitive material by containing it in a coating solution by any method such as a solution form, an emulsion dispersion form or a solid fine particle dispersion form.

An example of the well known emulsion dispersion method is a method in which an emulsion dispersion is mechanically prepared by dissolving the compound using an oil such as dibutyl phthalate, tricresyl phosphate, glyceryl triacetate or diethyl phthalate and an auxiliary solvent such as ethyl acetate or cyclohexanone.

Also, an example of the solid fine particle dispersion method is a method in which a solid dispersion is prepared by dispersing powder of the compound represented by formula (R) in an appropriate solvent such as water using ball mill, colloid mill, vibration ball mill, sand mill, jet mill, roller mill or ultra sonic wave. Preferred is a dispersion method which uses sandmill. In this connection, a protective colloid (e.g., polyvinyl alcohol) or a surface active agent (e.g., an anionic surface active agent such as sodium triisopropylnaphthalenesulfonate (a mixture of those having different substitution positions of three isopropyl groups)) may be used in preparing the dispersion. An antiseptic agent (e.g., benzoisothiazolinone sodium salt) may be contained in an aqueous dispersion.

(Compound of Formula (I))

The formula (I) is described in detail. R₁₁, R₁₂, R₁₃, R₁₄, R₁₅ and R₁₆ are each independently a hydrogen atom or a monovalent substituent group, or R₁₁, R₁₂, R₁₃, R₁₄, R₁₅ and R₁₆ may be combined with each other to form a ring, provided that all of R₁₁ to R₁₆ are not hydrogen atoms. Examples of the substituent group include an alkyl group (having preferably from 1 to 20, more preferably from 1 to 12, particularly preferably from 1 to 8, carbon atoms, and its examples include methyl, ethyl, n-propyl, iso-propyl, n-butyl, sec-butyl, iso-butyl, tert-butyl, n-pentyl, tert-pentyl, n-hexyl, n-octyl, n-decyl, n-hexadecyl, cyclopropyl, cyclopentyl, cyclohexyl and benzyl groups), an alkenyl group (having preferably from 2 to 20, more preferably from 2 to 12, particularly preferably from 2 to 8, carbon atoms, and its examples include vinyl, allyl, 2-butenyl and 3-pentenyl groups), an alkynyl group (having preferably from 2 to 20, more preferably from 2 to 12, particularly preferably from 2 to 8, carbon atoms, and its examples include propargyl and 3-pentinyl), an aryl group (having preferably from 6 to 30, more preferably from 6 to 20, particularly preferably from 6 to 12, carbon atoms, and its examples include phenyl, p-methylphenyl and naphthyl), an amino group (having preferably from 0 to 20, more preferably from 0 to 10, particularly preferably from 0 to 6, carbon atoms, and its examples include amino, methylamino, dimethylamino, diethylamino and dibenzylamino), an alkoxy group (having preferably from 1 to 20, more preferably from 1 to 12, particularly preferably from 1 to 8, carbon atoms, and its examples include methoxy, ethoxy, isopropoxy and butoxy), an aryloxy group (having preferably from 6 to 20, more preferably from 6 to 16, particularly preferably from 6 to 12, carbon atoms, and its examples include phenyloxy and 2-naphthyloxy), an acyl group (having preferably from 1 to 20, more preferably from 1 to 16, particularly preferably from 1 to 12, carbon atoms, and its examples include acetyl, benzoyl, formyl and pivaloyl), an alkoxycarbonyl group (having preferably from 2 to 20, more preferably from 2 to 16, particularly preferably from 2 to 12, carbon atoms, and its examples include methoxycarbonyl and ethoxycarbonyl), an aryloxycarbonyl group (having preferably from 7 to 20, more preferably from 7 to 16, particularly preferably from 7 to 10, carbon atoms, and its examples include phenyloxycarbonyl), an acyloxy group (having preferably from 2 to 20, more preferably from 2 to 16, particularly preferably from 2 to 10, carbon atoms, and its examples include acetoxy and benzoyloxy), an acylamino group (having preferably from 2 to 20, more preferably from 2 to 16, particularly preferably from 2 to 10, carbon atoms, and its examples include acetylamino and benzoylamino), an alkoxycarbonylamino group (having preferably from 2 to 20, more preferably from 2 to 16, particularly preferably from 2 to 12, carbon atoms, and its examples include methoxycarbonylamino), an aryloxycarbonylamino group (having preferably from 7 to 20, more preferably from 7 to 16, particularly preferably from 7 to 12, carbon atoms, and its examples include phenyloxycarbonylamino), a sulfonylamino group (having preferably from 1 to 20, more preferably from 1 to 16, particularly preferably from 1 to 12, carbon atoms, and its examples include methanesulfonylamino and benzenesulfonylamino), a sulfamoyl group (having preferably from 0 to 20, more preferably from 0 to 16, particularly preferably from 0 to 12, carbon atoms, and its examples include sulfamoyl, methylsulfamoyl, dimethylsulfamoyl and phenylsulfamoyl), a carbamoyl group (having preferably from 1 to 20, more preferably from 1 to 16, particularly preferably from 1 to 12, carbon atoms, and its examples include carbamoyl, methylcarbamoyl, diethylcarbamoyl and phenylcarbamoyl), an alkylthio group (having preferably from 1 to 20, more preferably from 1 to 16, particularly preferably from 1 to 12, carbon atoms, and its examples include methylthio and ethylthio), an arylthio group (having preferably from 6 to 20, more preferably from 6 to 16, particularly preferably from 6 to 12, carbon atoms, and its examples include phenylthio), a sulfonyl group (having preferably from 1 to 20, more preferably from 1 to 16, particularly preferably from 1 to 12, carbon atoms, and its examples include mesyl and tosyl), a sulfinyl group (having preferably from 1 to 20, more preferably from 1 to 16, particularly preferably from 1 to 12, carbon atoms, and its examples include methanesulfinyl and benzenesulfinyl), a ureido group (having preferably from 1 to 20, more preferably from 1 to 16, particularly preferably from 1 to 12, carbon atoms, and its examples include ureido, methylureido and phenylureido), a phosphoric amido group (having preferably from 1 to 20, more preferably from 1 to 16, particularly preferably from 1 to 12, carbon atoms, and its examples include diethylphosphoric amido and phenylphosphoric amido), hydroxy group, mercapto group, a halogen atom (e.g., fluorine atom, chlorine atom, bromine atom or iodine atom), cyano group, sulfo group, carboxyl group, nitro group, hydroxamic acid group, sulfino group, hydrazino group and a heterocyclic group (e.g., imidazolyl, pyridyl, furyl, piperidyl, morpholino or thienyl). These substituent groups may be further substituted and the substituent groups capable of forming salts may form salts. Examples of the ring formed by combining R₁ to R₁₆ include dioxolene ring and benzene ring.

According to the compound of formula (I) of the invention, preferred as R₁₁, R₁₂, R₁₃ and R₁₄ are a hydrogen atom, an alkyl group, an aryl group, a halogen atom and an acyl group, more preferred are a hydrogen atom, an alkyl group, an aryl group and an acyl group, and particularly preferred are a hydrogen atom and an alkyl group. Preferred as R₁₅ and R₁₆ is a hydrogen atom.

The compounds represented by formula (I) of the invention can be easily synthesized by those skilled in the art by known methods described, e.g., in R. G. ElderField, “Heterocyclic Compounds”, John Wiley and Sons, Vol. 1-9 (1950-1967) and A. R. Katritzky, “Comprehensive Heterocyclic Chemistry”, Pergamon Press (1984).

Illustrative examples of the compounds represented by formula (I) are shown below, though the invention is not limited thereto.

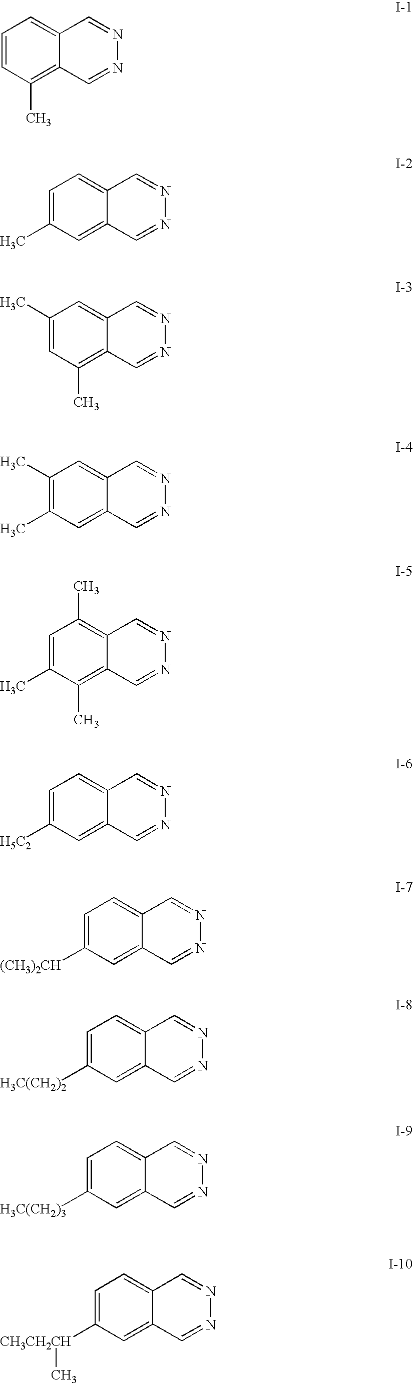

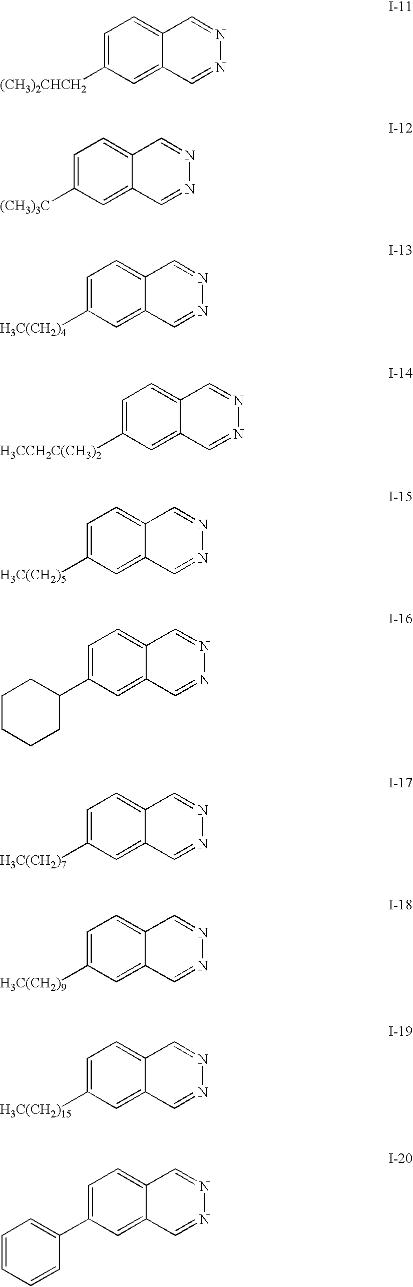

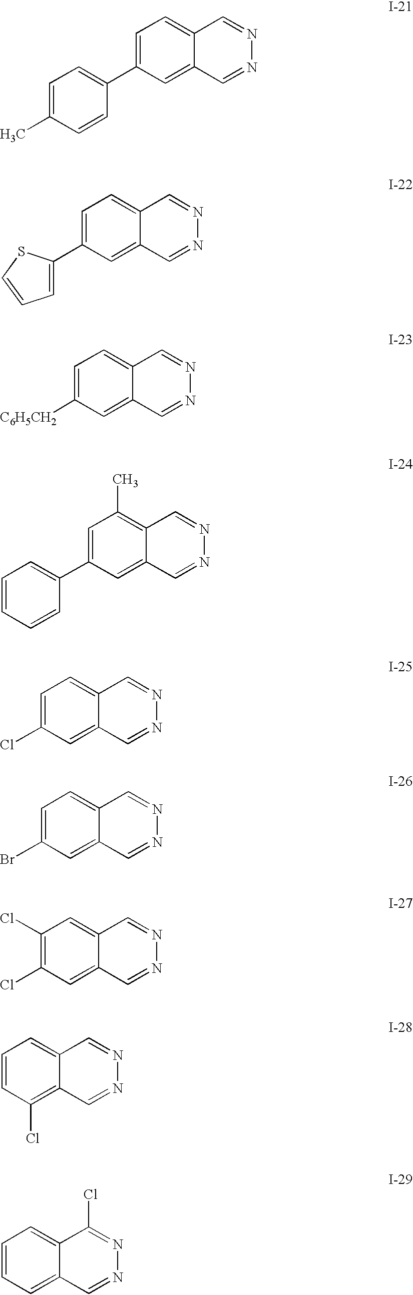

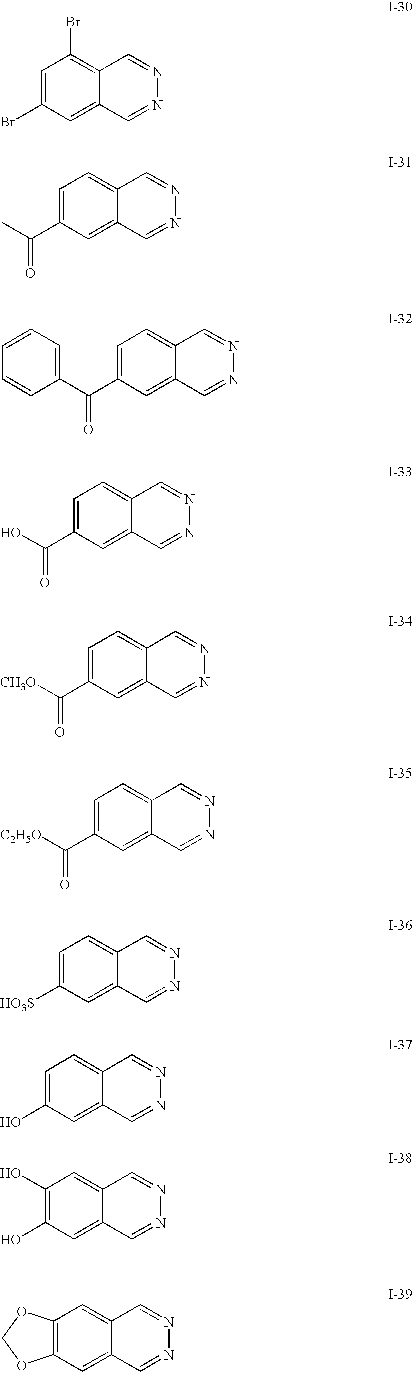

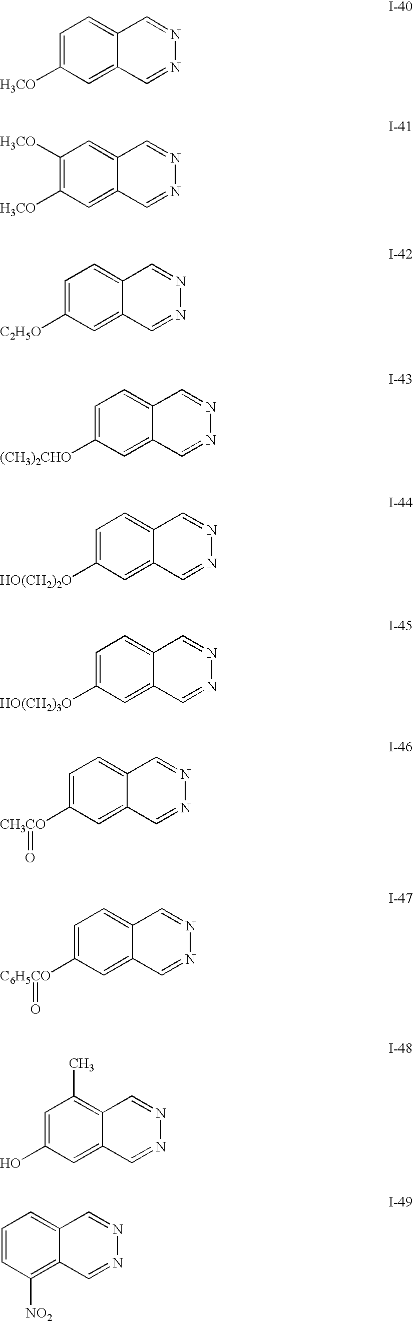

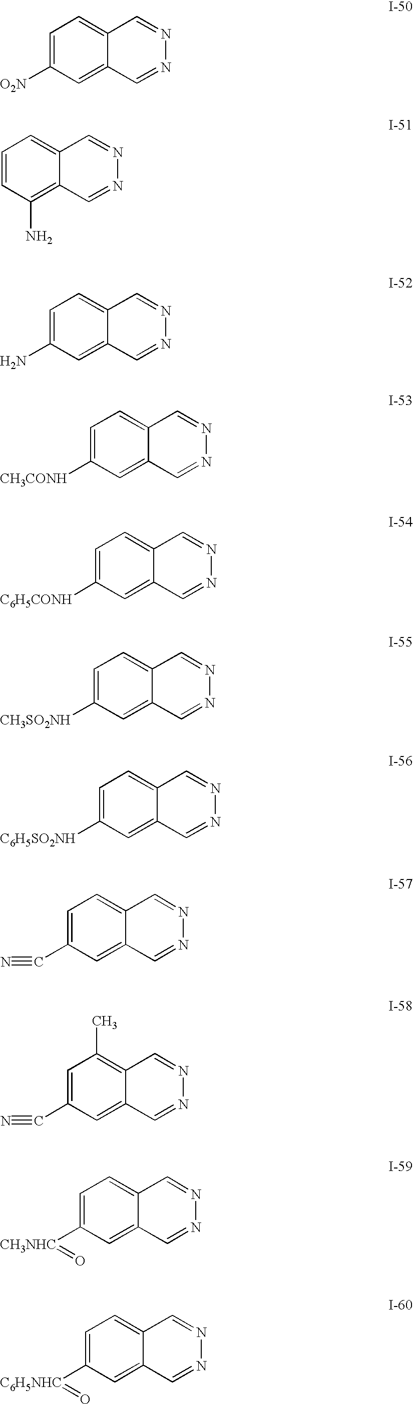

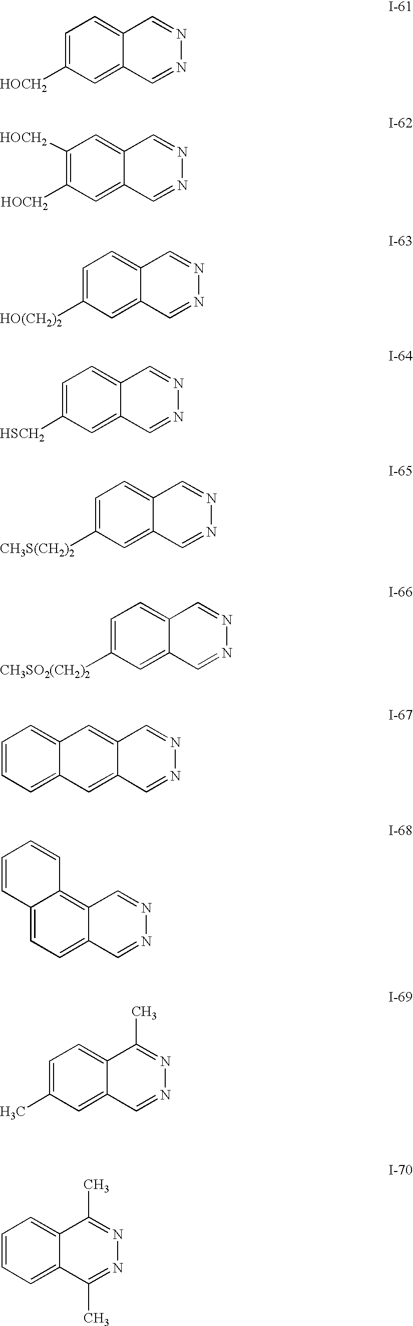

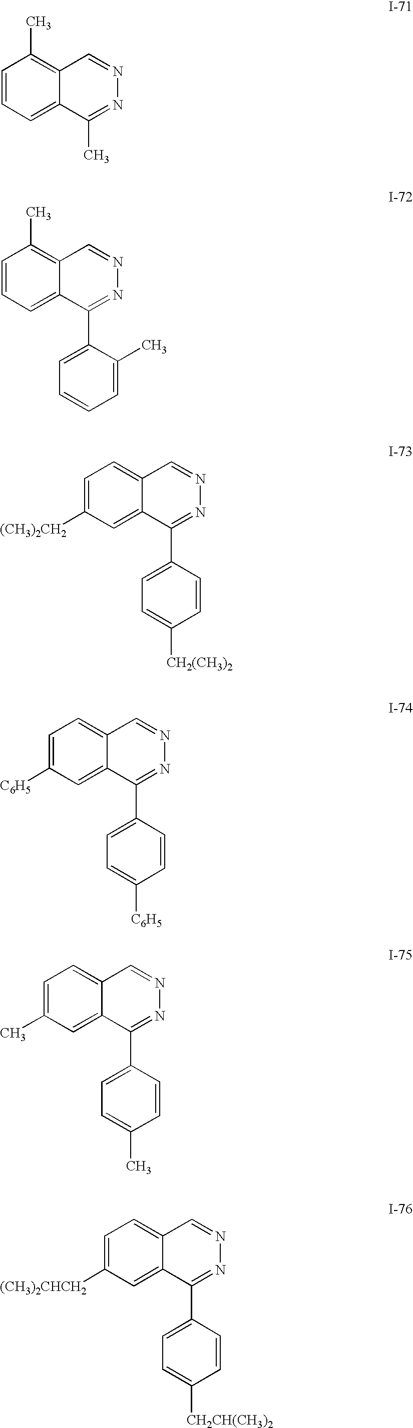

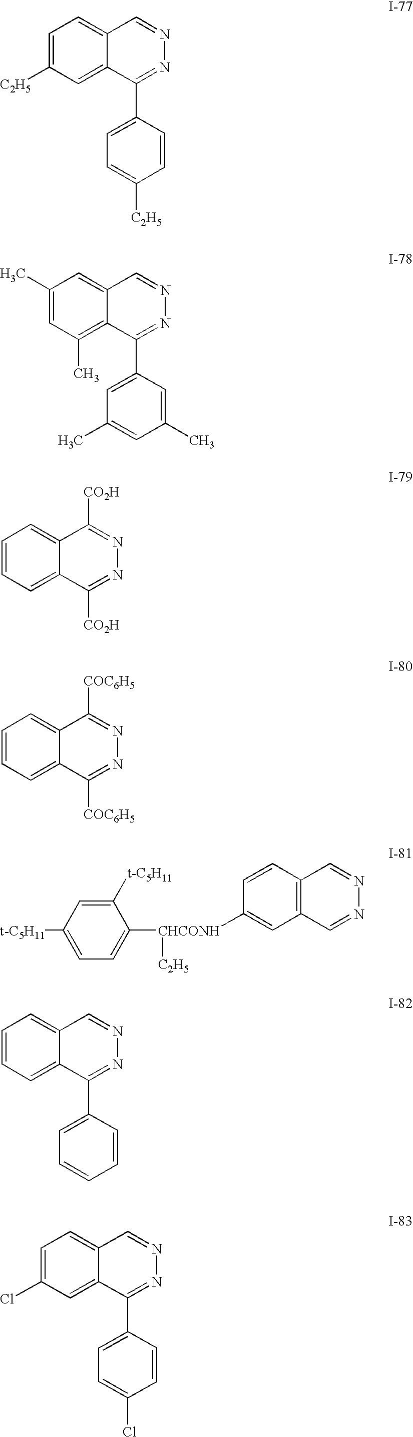

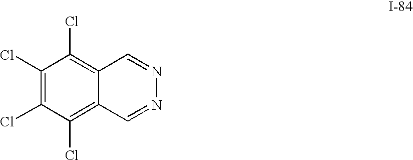

The compound represented by formula (I) of the invention can be added to the photosensitive layer which can become an image forming layer or a non-sensitive layer such as a protective layer on the image forming layer side of the heat-developable photosensitive material.

Though it differs depending on the desired purpose, it is desirable to add the compound represented by formula (I) of the invention in an amount of from 10⁻⁴ to 1 mol/Ag, preferably from 10⁻³ to 0.3 mol/Ag, more preferably from 10⁻³ to 0.1 mol/Ag, per 1 mol Ag.

The compound represented by formula (I) of the invention can be added by any method such as solution, powder or solid fine particle dispersion. The solid fine particle dispersion is carried out by a well known finely divided means (e.g., ball mill, vibration ball mill, sand mill, colloid mill, jet mill or roller mill). Also, a dispersion auxiliary may be used in carrying out the solid fine particle dispersion.

Melting point of the compound represented by formula (I) of the invention is preferably −20° C. or more and 130° C. or less, more preferably 30° C. or more and 100° C. or less, particularly preferably 50° C. or more and 80° C. or less.

(Developing Enhancer)

In the heat-developable photosensitive material of the invention, the sulfonamide phenol compounds represented by formula (A) described in Japanese Patent Laid-Open No. 2000-267222 and Japanese Patent Laid-Open No. 2000-330234, the hindered phenol compounds represented by formula (II) described in Japanese Patent Laid-Open No. 2001-92075, the hydrazine compounds represented by formula (I) described in Japanese Patent Laid-Open No. 62895/1998 and Japanese Patent Laid-Open No. 15116/1999 and represented by formula (1) described in Japanese Patent Application No. 2001-074278 and the phenol or naphthol compounds represented by formula (2) described in Japanese Patent Application No. 2000-76240 are desirably used as the developing enhancer. These developing enhancers are used within the range of from 0.1 to 20% by mol, preferably within the range of from 0.5 to 10% by mol, more preferably within the range of from 1 to 5% by mol, based on the reducing agent. As the introducing method into the photosensitive material, a method similar to the case of the reducing agent can be cited, and it is particularly desirable to add as a solid dispersion or an emulsion dispersion. When it is added as an emulsion dispersion, it is desirable to add as an emulsion dispersion prepared by dispersing it using a high boiling point solvent which is solid at ordinary temperature and a low boiling point auxiliary solvent, or as a so-called oil-less emulsion dispersion which does not use high boiling point solvent.

According to the invention, particularly preferred among these developing enhancers are the hydrazine compounds represented by formula (1) described in Japanese Patent Application No. 2001-074278and the phenol or naphthol compounds represented by formula (2) described in Japanese Patent Application No. 2000-76240.

Illustrative examples of the preferred developing enhancer of the invention are shown in the following.

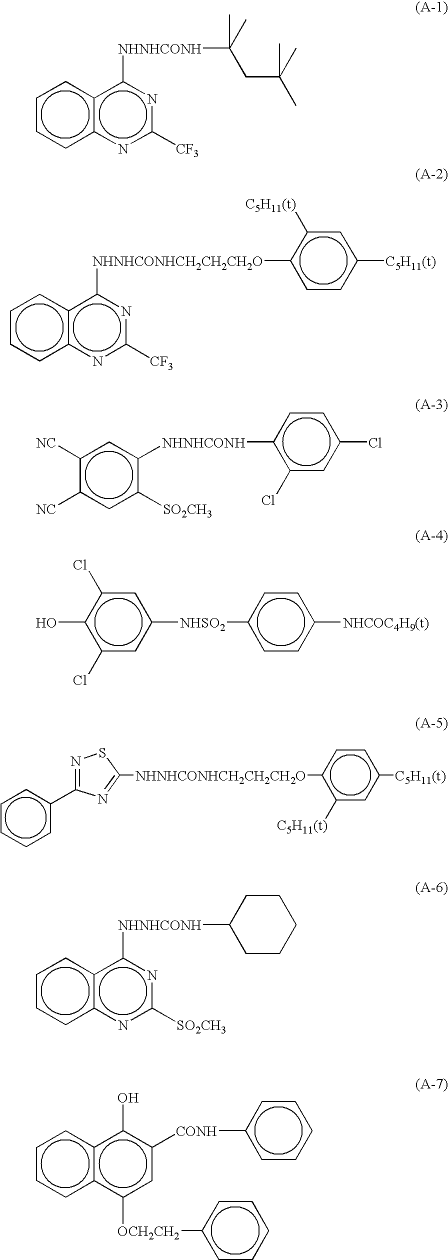

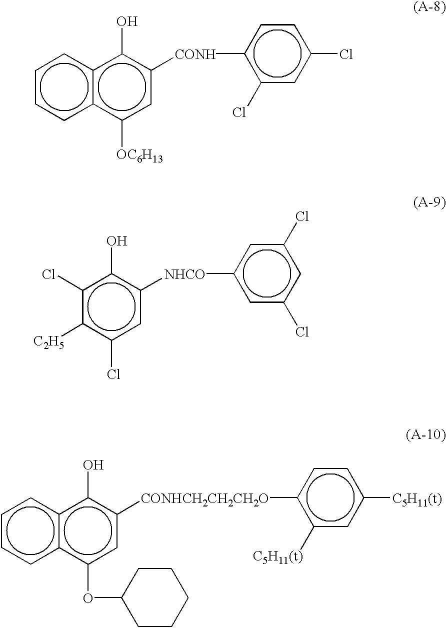

(Donor Compound)

When the reducing agent of the invention has an aromatic hydroxyl group (—OH) or an amino group, particularly in the case of the bisphenol, it is desirable to use it jointly with a non-reducing compound having a group which can form hydrogen bond with such a group.

Examples of the group which forms hydrogen bond with hydroxyl group or amino group include phosphoryl group, sulfoxido group, sulfonyl group, carbonyl group, amido group, ester group, urethane group, ureido group, tertiary amino group and a nitrogen-containing aromatic group. Preferred among them are compounds having phosphoryl group, sulfoxido group, amido group (provided that it does not have >N—H group but is blocked as >N—Ra (Ra is a substituent group other than H)), urethane group (provided that it does not have >N—H group but is blocked as >N—Ra (Ra is a substituent group other than H)) and ureido group (provided that it does not have >N—H group but is blocked as >N—Ra (Ra is a substituent group other than H)).

According to the invention, particularly desirable hydrogen bond-forming compounds are compounds represented by the following formula (D):

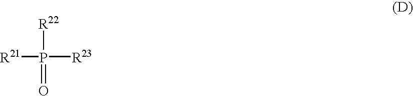

In the formula (D), R²¹ to R²³ represent each independently alkyl group, aryl group, alkoxy group, aryloxy group, amino group or heterocyclic group, and these groups may be unsubstituted or have substituent groups.

Examples of the substituent groups when R²¹ to R²³ have substituent groups include halogen atom, alkyl group, aryl group, alkoxy group, amino group, acyl group, acylamino group, alkylthio group, arylthio group, sulfonamido group, acyloxy group, oxycarbonyl group, carbamoyl group, sulfamoyl group, sulfonyl group and phosphoryl group, and preferred as the substituent group is alkyl group or aryl group and its examples include methyl group, ethyl group, isopropyl group, t-butyl group, t-octyl group, phenyl group, 4-alkoxyphenyl group and 4-acyloxyphenyl group.

Illustrative examples of the alkyl group of R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenethyl group and 2-phenoxypropyl group.

Examples of aryl group include phenyl group, cresyl group, xylyl group, naphthyl group, 4-t-butylphenyl group, 4-t-octylphenylgroup, 4-anisidyl group and3,5-dichlorophenyl group.

Examples of alkoxy group include methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group and benzyloxy group.

Examples of aryloxy group include phenoxy group, cresyloxy group, isopropylphenoxy group, 4-t-butylphenoxy group, naphthoxy group and biphenyloxy group.

Examples of amino group include dimethylamino group, diethylamino group, dibutylamino group, dioctylamino group, N-methyl-N-hexylamino group, dicyclohexylamino group, diphenylamino group and N-methyl-N-phenylamino group.

As R²¹ to R²³, alkyl group, aryl group, alkoxy group and aryloxy group are desirable. From the viewpoint of the effect of the invention, it is desirable that at least one of R²¹ to R²³ is alkyl group or aryl group, more desirably, two or more of them are alkyl group or aryl group. Also, in view of obtaining with low cost, it is desirable that R²¹ to R²³ are the same group.

Illustrative examples of the hydrogen bond-forming compounds including the compounds of formula (D) in the invention are shown below, but the invention is not limited thereto.

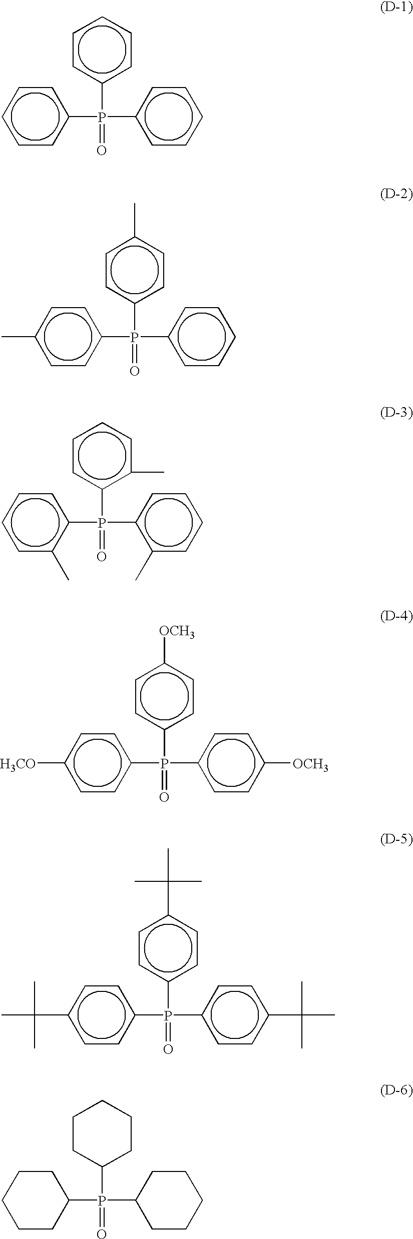

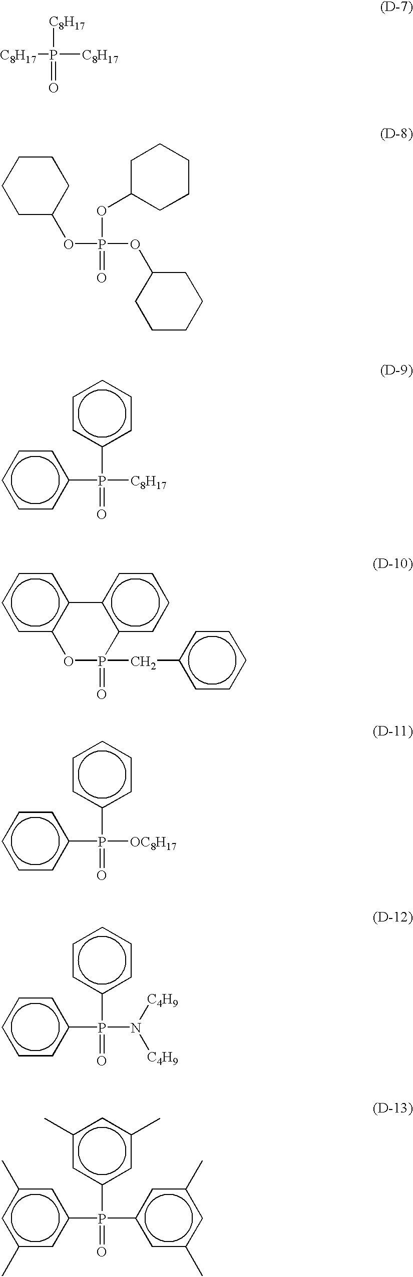

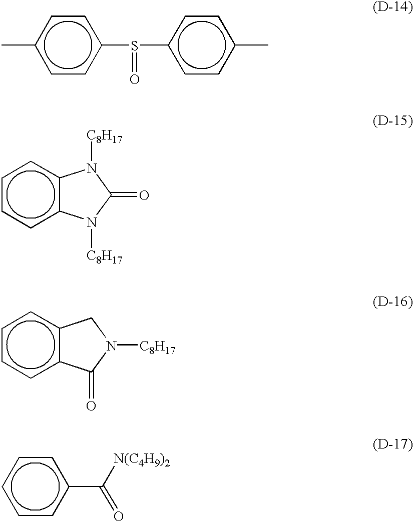

As other illustrative examples of the hydrogen bond-forming compounds in addition to the above, those which are described in Japanese Patent Laid-Open No. 2001-281793 and Japanese Patent Laid-Open No. 2002-14438 can be cited.

Similar to the case of the reducing agent, the compound of formula (D) can be used in the photosensitive material by containing in a coating solution in a solution form, an emulsion dispersion form or a solid fine particle dispersion form. Since the compound of formula (D) forms a hydrogen bond-forming complex with a compound having phenolic hydroxyl group or amino group under a dissolved condition, it can be isolated as the complex under a crystalline condition depending on the combination of the reducing agent with the compound of formula (D).

The use of the thus isolated crystal powder as a solid fine particle dispersion is particularly desirable for obtaining stable performance. In addition, a method in which the reducing agent and the compound of formula (D) of the invention are mixed as powders and subjected to complex formation at the time of dispersion by a means such as sand grinder mill using an appropriate dispersing agent can also be used preferably.

The compound of formula (D) is used preferably within the range of from 1 to 200% by mol, more preferably within the range of from 10 to 150% by mol, further preferably within the range of from 30 to 100% by mol, based on the reducing agent.

(Description of Silver Halide)

The photosensitive silver halide to be used in the invention is not particularly limited as a halogen composition, and silver chloride, silver chlorobromide, silver bromide, silver iodidobromide, silver iodidochlorobromide and silver iodide can be used. Among them, silver bromide and silver iodidobromide are desirable. Distribution of the halogen composition in particles may be uniform, a state in which the halogen composition is changed in steps or a state in which it is continuously changed. Also, silver halide particles having a core/shell structure can be desirably used. Preferred as structures are 2 to 5 layer structures, and core/shell particles of 2 to 4 layer structures can be used more preferably. In addition, a technique for localizing silver bromide or silver iodide on the surface of particles of silver chloride, silver bromide or silver chlorobromide can also be used desirably.

The method for forming the sensitive silver halide is well known in this field and, e.g., the methods described in Research Disclosure, No. 17029, June, 1978, and U.S. Pat. No. 3,700,458 can be used, but illustratively, a method in which a sensitive silver halide is prepared by adding a silver supplying compound and a halogen supplying compound to a solution of gelatin or other polymer and then mixed with an organic silver salt is used. Also preferred are the method described in Japanese Patent Laid-Open No. 119374/1999 (paragraph numbers 0217 to 0224) and the methods described in Japanese Patent Laid-Open No. 352627/1999 and Japanese Patent Laid-Open No. 2000-347335.

The size of photosensitive silver halide grain is preferably small for the purpose of suppressing occurrence of white turbidity after the image formation, and illustratively, it is preferably 0.20 μm or less, more preferably from 0.01 μm to 0.15 μm, still more preferably from 0.02 μm to 0.12 μm. The grain size as used herein means a diameter of a circle image having the same area as the projected area of a silver halide grain (in the case of a tabular grain, the projected area of a main plane).

Examples of the shape of a silver halide grain include cubic form, octahedral form, tabular form, spherical form, bar form and potato-like form. In the invention, a cubic grain is particularly preferred. A silver halide grain having rounded corners can also be preferably used. Although the face index (Miller indices) of the outer surface of a photosensitive silver halide grain is not particularly limited, [100] faces capable of giving a high spectral sensitization efficiency upon adsorption of a spectral sensitizing dye preferably occupy a high percentage. The percentage is preferably 50% or more, more preferably 65% or more, still more preferably 80% or more. The percentage of [100] faces according to the Miller indices can be determined by the method described in T. Tani, J. Imaging Sci., 29, 165 (1985) utilizing the adsorption dependency of [111] face and [100] face when a sensitizing dye is adsorbed.

(Heavy Metal)

According to the invention, a silver halide grain having allowed a hexacyano metal complex to be present on the outermost surface thereof is preferred. Examples of the hexacyano metal complex include [Fe(CN)₆]⁴⁻, [Fe(CN)₆]³⁻, [Ru(CN)₆]⁴⁻, [Os (CN)₆]⁴⁻, [Co(CN)₆]³⁻, [Rh(CN)₆]³⁻, [Ir(CN)₆]³⁻, [Cr(CN)₆]³⁻ and [Re(CN)₆]³⁻. In the invention, hexacyano Fe complexes are preferred.

The hexacyano metal complex is present in the form of ion in an aqueous solution and therefore, the counter cation is not important but a cation easily miscible with water and suitable for the precipitation operation of a silver halide emulsion is preferably used, and its examples include alkali metal ions such as sodium ion, potassium ion, rubidium ion, cesium ion and lithium ion, ammonium ions, and alkylammonium ions (e.g., tetramethylammonium ion, tetraethylammonium ion, tetrapropylammonium ion, tetra(n-butyl)ammonium ion).

The hexacyano metal complex can be added after mixing it with water, a mixed solvent of water and an appropriate organic solvent miscible with water (e.g., an alcohol, an ether, aglycol, a ketone, an ester or an amide), or gelatin.

The amount of the hexacyano metal complex added is preferably from 1×10⁻⁵ mol to 1×10⁻² mol, more preferably from 1×10⁻⁴ mol to 1×10⁻³ mol, per mol of silver.

For allowing the hexacyano metal complex to exist on the outermost surface of a silver halide grain, the hexacyano metal complex is directly added after the completion of addition of an aqueous silver nitrate solution to be used for the grain formation but before the starting of chemical sensitization step of performing chalcogen sensitization such as sulfur sensitization, selenium sensitization and tellurium sensitization or noble metal sensitization such as gold sensitization, e.g., before the completion of charging step, during the water washing step, during the dispersion step, or before the chemical sensitization step. In order to prevent growth of silver halide fine grains, the hexacyano metal complex is preferably added without delay after the grain formation and is preferably added before the completion of charging step.

In this connection, the addition of hexacyano metal complex may be started after silver nitrate added for the grain formation is added to consume 96% by mass, preferably 98% by mass, more preferably 99% by mass, of the total amount.

When the hexacyano metal complex is added after the addition of an aqueous silver nitrate solution immediately before the completion of grain formation, the hexacyano metal complex can adsorb to the outermost surface of a silver halide grain and most of the complexes adsorbed form a sparingly-soluble salt with silver ion on the grain surface. Since this silver salt of hexacyanoferrate (II) is a salt more sparingly soluble than AgI, the fine grains can be prevented from re-dissolving, making it possible to produce silver halide fine grains having a small grain size.

The photosensitive silver halide grain for use in the invention can contain a metal of Group VIII to Group X in the Periodic Table (showing Group I to Group XVIII) or a metal complex thereof. The metal of Group VIII to Group X of the Periodic Table or the center metal of metal complex is preferably rhodium, ruthenium or iridium. These metal complexes may be used individually, or two or more complexes of the same or different metals may be used in combination. The metal or metal complex content is preferably from 1×10⁻⁹ mol to 1×10⁻³ mol per mol of silver. These heavy metals and metal complexes and the addition methods therefor are described in Japanese Patent Laid-Open No. 225449/1995, Japanese Patent Laid-Open No. 65021/1999 (paragraph Nos. 0018 to 0024) and Japanese Patent Laid-Open No. 119374/1999 (paragraph Nos. 0227 to 0240).

Furthermore, the metal atoms (e.g., [Fe(CN)₆]⁴⁻) which can be contained in the silver halide grain for use in the invention, and the methods for desalting and chemical sensitization of a silver halide emulsion are described in Japanese Patent Laid-Open No. 84574/1999 (paragraph Nos. 0046 to 0050), Japanese Patent Laid-Open No. 65021/1999 (paragraph Nos. 0025 to 0031) and Japanese Patent Laid-Open No. 119374/1999 (paragraph Nos. 0242 to 0250).

(Gelatin for Photosensitive Silver Halide Emulsion)

For the gelatin contained in the photosensitive silver halide emulsion for use in the invention, various gelatins can be used. In order to maintain good dispersion state of the photosensitive silver halide emulsion in the organic silver salt-containing coating solution, a low molecular weight gelatin having a molecular weight of from 500 to 60,000 is preferably used. The low molecular weight gelatin may be used either during the grain formation or at the time of dispersion after desalting but is preferably used at the time of dispersion after desalting.

(Sensitizing Dye)

As for the sensitizing dye which can be used in the invention, a sensitizing dye capable of spectrally sensitizing a silver halide grain in the desired wavelength region when adsorbed to the silver halide grain and having a spectral sensitivity suitable for the spectral characteristics of exposure light source can be advantageously selected. Examples of the sensitizing dye and the addition method therefor include compounds described in Japanese Patent Laid-Open No. 65021/1999 (paragraph Nos. 0103 to 0109), compounds represented by formula (II) of Japanese Patent Laid-Open No. 186572/1998, dyes represented by formula (I) and described in paragraph No. 0106 of Japanese Patent Laid-Open No. 119374/1999, dyes described in U.S. Pat. Nos. 5,510,236 and 3,871,887 (Example 5), dyes disclosed in Japanese Patent Laid-Open No. 96131/1990 and Japanese Patent Laid-Open No. 48753/1984, and those described in EP-A-0803764A1 (page 19, line 38 to page 20, line 35) and Japanese Patent Laid-Open No. 2001-272747, Japanese Patent Laid-Open No. 2001-290238 and Japanese Patent Laid-Open No. 2002-23306. These sensitizing dyes may be used individually or in combination of two or more thereof. According to the invention, the sensitizing dye is preferably added to the silver halide emulsion in the time period after desalting until the coating, more preferably after desalting until initiation of chemical ripening.

According to the invention, the amount of the sensitizing dye added may be appropriately selected according to the performance such as sensitivity or fog but is preferably from 10⁻⁶ to 1 mol, more preferably from 10⁻⁴ to 10⁻¹ mol, per mol of silver halide in the photosensitive layer.

According to the invention, a super-sensitizer may be used for improving the spectral sensitization efficiency. Examples of the super-sensitizer for use in the invention include the compounds described in EP-A-587,338, U.S. Pat. Nos. 3,877,943 and 4,873,184, Japanese Patent Laid-Open No. 341432/1993, Japanese Patent Laid-Open No. 109547/1999 and Japanese Patent Laid-Open No. 111543/1998.

(Chemical Sensitization)

The photosensitive silver halide grain for use in the invention is preferably subjected to chemical sensitization by sulfur sensitization, selenium sensitization or tellurium sensitization. As for the compound which is preferably used in the sulfur sensitization, selenium sensitization or tellurium sensitization, known compounds can be used, e.g., compounds described in Japanese Patent Laid-Open No. 128768/1995 can be used. According to the invention, tellurium sensitization is particularly preferred and compounds described in Japanese Patent Laid-Open No. 65021/1999 (paragraph No. 0030) and compounds represented by formulae (II), (III) and (IV) of Japanese Patent Laid-Open No. 313284/1993 are more preferred.

According to the invention, the chemical sensitization may be performed at any stage after the grain formation but before the coating and, e.g., can be performed, after desalting, (1) before spectral sensitization, (2) simultaneously with spectral sensitization, (3) after spectral sensitization or (4) immediately before coating. The chemical sensitization is particularly preferably performed after spectral sensitization.

The amount used of the sulfur, selenium or tellurium sensitizer for use in the invention varies depending on conditions such as the silver halide grain used and chemical ripening conditions but is from 10⁻⁸ to 10⁻² mol, preferably on the order from 10⁻⁷ to 10⁻³ mol, per mol of silver halide. In the invention, the conditions for chemical sensitization is not particularly limited but the pH is from 5 to 8, the pAg is from 6 to 11 and the temperature is approximately from 40 to 95° C.

In the silver halide emulsion for use in the invention, a thiosulfonic acid compound may be added by the method described in EP-A-293,917.

In the photosensitive material for use in the invention, only one photosensitive silver halide emulsion may be used or two or more emulsions (different, e.g., in the average grain size, the halogen composition, the crystal habit or the chemical sensitization conditions) maybe used in combination. By using two or more photosensitive silver halide emulsions different in the sensitivity, gradation can be controlled. Examples of the technique thereon include those described in Japanese Patent Laid-Open No. 119341/1982, Japanese Patent Laid-Open No. 106125/1978, Japanese Patent Laid-Open No. 3929/1972, Japanese Patent Laid-Open No. 55730/1973, Japanese Patent Laid-Open No. 5187/1971, Japanese Patent Laid-Open No. 73627/1975 and Japanese Patent Laid-Open No. 150841/1982. The difference in sensitivity between respective emulsions is preferably 0.2 logE or more.

The amount of the photosensitive silver halide added is, in terms of the coated silver amount per 1 m² of the photosensitive material, preferably from 0.03 to 0.6 g/m², more preferably from 0.07 to 0.4 g/m², most preferably from 0.05 to 0.3 g/m², and the amount of the photosensitive silver halide added per 1 mol of the organic silver salt is preferably from 0.01 to 0.5 mol, more preferably from 0.02 to 0.3 mol, still more preferably from 0.03 to 0.2 mol.

The method for and the conditions in the mixing of separately prepared photosensitive silver halide and organic silver salt are not particularly limited insofar as the effect of the invention is satisfactorily brought out but a method of mixing silver halide grains and organic silver salt each after the completion of preparation by a high-speed agitator or in a ball mill, a sand mill, a colloid mill, a vibration mill or a homogenizer, or a method of completing the preparation of an organic silver salt by mixing a photosensitive silver halide of which preparation is completed, at any timing during the preparation of organic silver salt may be used. For controlling the photographic characteristics, it is preferred to mix two or more aqueous dispersions of organic silver salt with two or more aqueous dispersions of photosensitive silver salt.

In the invention, the timing of adding silver halide to a coating solution for the image-forming layer is preferably from 180 minutes before coating to immediately before coating, preferably from 60 minutes to 10 seconds before coating, however, the mixing method and the mixing conditions are not particularly limited insofar as the effect of the invention can be satisfactorily brought out. Specific examples of the mixing method include a method of mixing them in a tank designed to give a desired average residence time which is calculated from the addition flow rate and the liquid transfer amount to the coater, and a method using a static mixer described in N. Harnby, M. F. Edwards and A. W. Nienow (translated by Koji Takahashi), “Ekitai Kongo Gijutsu (Liquid Mixing Technique)”, Chap. 8, Nikkan Kogyo Shinbun Sha (1989).

(Binder)

According to the invention, the binder used for the organic silver salt-containing layer may be any polymer and the suitable binder is transparent or translucent and generally colorless, and examples thereof include natural resins, polymers and copolymers, synthetic resins, polymers and copolymers, and film-forming media such as gelatins, rubbers, poly(vinyl alcohol)s, hydroxyethyl celluloses, cellulose acetates, cellulose acetate butyrates, poly(vinyl pyrrolidone)s, casein, starch, poly(acrylic acid)s, poly(methyl methacrylate)s, poly(vinyl chloride)s, poly (methacrylic acid)s, styrene-maleic anhydride copolymers, styrene-acrylonitrile copolymers, styrene-butadiene copolymers, poly (vinyl acetal)s (e.g., poly(vinyl formal) and poly(vinyl butyral)), poly(ester)s, poly(urethane)s, phenoxy resin, poly(vinylidene chloride)s, poly(epoxide)s, poly(carbonate)s, poly(vinyl acetate)s, poly(olefin)s, cellulose esters and poly(amide)s. The binder may also be coated and formed from water, an organic solvent or an emulsion.

When 60% by mass or more of the solvent in the organic silver salt-containing layer is water, it is desirable to use polymer latex of a styrene-butadiene copolymer as the binder, and when 60% by mass or more of the solvent is an organic solvent, it is desirable to use polyvinyl butyral as the binder.

When 60% by weight or more of the coating solution solvent in the photosensitive layer is water, it is desirable that preferably from 60% by weight to 100% by weight, more preferably from 80% by weight to 100% by weight, of the binder is a polymer latex. Also, it is desirable to use a styrene-butadiene copolymer latex as the polymer latex.

When 60% by weight or more of the coating solution solvent in the photosensitive layer is an organic solvent, it is desirable that preferably from 60% by weight to 100% by weight, more preferably from 80% by weight to 100% by weight, of the binder is polyvinyl butyral.

According to the invention, the binder in the organic silver salt-containing layer preferably has a glass transition temperature of from 10° C. to 80° C. (hereinafter sometimes called a high Tg binder), more preferably from 20° C. to 70° C., still more preferably from 23° C. to 65° C. When the binder is polyvinyl butyral, particularly preferred Tg is from 60° C. to 80° C.

In this connection, the Tg is calculated by the following formula in the specification.

1/Tg=Σ(Xi/Tgi)

In this case, it is assumed that the polymer is resultant of the copolymerization of n monomer components from i=1 to n. Xi is the weight fraction (ΣXi=1) of the i-th monomer and Tgi is the glass transition temperature (absolute temperature) of a homopolymer of the i-th monomer, provided that Σ is the sum of i=1 to n.

In this connection, for the glass transition temperature (Tgi) of a homopolymer of each monomer, the values described in Polymer Handbook (3rd Edition) (edited by J. Brandrup and E. H. Immergut (Wiley-Interscience, 1989)) are employed.

For the binder, a single polymer species may be used or two or more of the n may be used in combination as occasion demands. Also, a binder having a glass transition temperature of 20° C. or more and a binder having a glass transition temperature of less than 20° C. may be used in combination. When two or more polymers different in Tg are blended, the weight average Tg thereof preferably falls within the above range.

According to the invention, the performance is enhanced when the organic silver salt-containing layer is formed by coating and drying a coating solution where 30% by weight or more of the solvent is water, and furthermore when the binder of the organic silver salt-containing layer is soluble or dispersible in an aqueous solvent (aqueous solvent), particularly when the binder is composed of a polymer latex having an equilibrium moisture content of 2% by weight or less at 25° C. and 60% RH.

In a most preferred form, the binder is prepared to have an ion conductivity of 2.5 mS/cm or less, and examples of the method for such preparation include a method of synthesizing a polymer and then purifying it using a membrane having a separating function.

The term an “aqueous solvent” in which the above polymer is soluble or dispersible means water or a mixture of water and 70% by mass or less of a water-miscible organic solvent.

Examples of the water-miscible organic solvent include alcohol-base solvents such as methyl alcohol, ethyl alcohol and propyl alcohol, cellosolve-base solvents such as methyl cellosolve, ethyl cellosolve and butyl cellosolve, ethyl acetate and dimethylformamide.

In this connection, the term “aqueous solvent” is used herein also for a system where the polymer is not thermodynamically dissolved but is present in a so-called dispersed state.

Also, the term “equilibrium moisture content at 25° C. and 60% RH” can be expressed as follows using the weight W1 of a polymer in the humidity equilibration in an atmosphere of 25° C. and 60% RH and the weight W0 of a polymer in the absolute dry condition at 25° C.

Equilibrium moisture content at 25° C. and 60% RH=[(W1−W0)/W0]×100 (% by weight)

Regarding the definition and the measuring method of moisture content, e.g., Kobunshi Kogaku Koza 14, Kobunshi Zairyo Shiken Hou (Lecture 14 of Polymer Engineering, Polymer Material Testing Method) (The Society of Polymer Science, Japan, Chijin Shokan) may be referred to.

In the invention, the equilibrium moisture content at 25° C. and 60% RH of the binder polymer is preferably 2% by weight or less, more preferably from 0.01 to 1.5% by weight, still more preferably from 0.02 to 1% by weight.

In the present invention, a polymer dispersible in an aqueous solvent is particularly preferred. Examples of the dispersed state include a case where fine particles of a water-insoluble hydrophobic polymer are dispersed in the form of latex, and a case where polymer molecules are dispersed in the molecular state or by forming micelles, and either case is preferred. The average particle size of the dispersed particles is preferably from 1 to 50,000 nm, more preferably from 5 to 1,000 nm. The particle size distribution of the dispersed particles is not particularly limited and the dispersed particles may have either a wide particle size distribution or a monodisperse particle size distribution.

According to the invention, as a preferred embodiment of the polymer dispersible in an aqueous solvent, hydrophobic polymers such as acrylic polymers, poly(ester)s, rubbers (e.g., SBR resin), poly(urethane)s, poly(vinylchloride)s, poly(vinyl acetate)s, poly(vinylidene chloride)s and poly(olefin)s can be used preferably. These polymers may be a linear polymer, branched polymer or crosslinked polymer and also may be a homopolymer obtained by the polymerization of a single monomer or a copolymer obtained by the polymerization of two or more monomers. In the case of a copolymer, it may be a random copolymer or a block copolymer.

The molecular weight of the polymer is, in terms of the number average molecular weight, from 5,000 to 1,000,000, preferably from 10,000 to 200,000. If the molecular weight is too small, the emulsion layer formed is insufficient in the mechanical strength, whereas if the molecular weight is excessively large, the film forming property is poor.

Specific preferred examples of the polymer latex are set forth below. In the following, the polymer latex is expressed using starting material monomers, the numerical value in the parentheses is the unit of % by weight and the molecular weight is a number average molecular weight. In the case where a multifunctional monomer is used, since a crosslinked structure is formed and the concept of molecular weight cannot be applied, the term “crosslinkable” is shown and the molecular weight is omitted. Tg indicates a glass transition temperature.

P-1: latex of -MMA(70)-EA(27)-MAA(3)- (molecular weight 37,000)

P-2: latex of -MMA(70)-2EHA(20)-St(5)-AA(5)- (molecular weight 40,000)

P-3: latex of -St(50)-Bu(47)-MAA(3)- (crosslinkable)

P-4: latex of -St(68)-Bu(29)-AA(3)- (crosslinkable)

P-5: latex of -St(71)-Bu(26)-AA(3)- (crosslinkable, Tg 24° C.)

P-6: latex of -St(70)-Bu(27)-IA(3)- (crosslinkable)

P-7: latex of -St(75)-Bu(24)-AA(1)- (crosslinkable)

P-8: latex of -St(60)-Bu(35)-DVB(3)-MAA(2)- (crosslinkable)

P-9: latex of -St(70)-Bu(25)-DVB(2)-AA(3)- (crosslinkable)

P-10: latex of -VC(50)-MMA(20)-EA(20)-AN(5)-AA(5)- (molecular weight 80,000)

P-11: latex of -VDC(85)-MMA(5)-EA(5)-MAA(5)- (molecular weight 67,000)

P-12: latex of -Et(90)-MAA(10)- (molecular weight 12,000)

P-13: latex of -St(70)-2EHA(27)-AA(3) (molecular weight 130,000)

P-14: latex of -MMA(63)-EA(35)-AA(2) (molecular weight 33,000)

P-15: latex of -St(70.5)-Bu(26.5)-AA(3)- (crosslinkable, Tg 23° C.)

P-16: latex of -St(69.5)-Bu(27.5)-AA(3)- (crosslinkable, Tg 20.5° C.)

The abbreviations in the above structures indicate the following monomers: MMA; methyl methacrylate, EA; ethyl acrylate, MAA; methacrylic acid, 2EHA; 2-ethylhexyl acrylate, St; styrene, Bu; butadiene, AA; acrylic acid, DVB; divinylbenzene, VC; vinyl chloride, AN; acrylonitrile, VDC; vinylidene chloride, Et; ethylene, and IA; itaconic acid.

These polymer latexes are commercially available and the following polymers may be used. Examples of the acrylic polymer include Sebian A-4635, 4718 and 4601 (produced by Daicel Chemical Industries, Ltd.) and Nipol Lx811, 814, 821, 820 and 857 (produced by Nippon Zeon K.K.), examples of the poly(ester)s include FINETEX ES650, 611, 675 and 850 (produced by Dai-Nippon Ink & Chemicals, Inc.) and WD-size and WMS (produced by Eastman Chemical Products, Inc.), examples of the poly(urethane)s include HYDRAN AP10, 20, 30 and 40 (produced by Dai-Nippon Ink & Chemicals, Inc.), examples of the rubbers include LACSTAR 7310K, 3307B, 4700H and 7132C (produced by Dai-Nippon Ink & Chemicals, Inc.) and Nipol Lx416, 410, 438C and 2507 (produced by Nippon Zeon K.K.); examples of the poly(vinyl chlorides) include “G351 and G576” (produced by Nippon Zeon K.K.), examples of the poly(vinylidene chlorides) include L502 and L513 (produced by Asahi Chemical Industry Co., Ltd.), and examples of the poly(olefin)s include Chemipearl S120 and SA100 (produced by Mitsui Petrochemical Industries, Ltd.).

These polymer latexes may be used individually or, if desired, as a blend of two or more thereof.

The polymer latex for use in the invention is particularly preferably a latex of styrene-butadiene copolymer. In the styrene-butadiene copolymer, a weight ratio of the styrene monomer unit to the butadiene monomer unit is preferably from 40:60 to 95:5. Furthermore, the styrene monomer unit and the butadiene monomer unit preferably account for 60 to 99% by weight of the copolymer. Preferred molecular weight range is as described in the foregoing.

Examples of the styrene-butadiene copolymer latex which is preferably used in the invention include the above latexes P-3 to P-8, P14 and P-15 and commercially available products LACSTAR-3307B, 7132C and Nipol Lx416.

The organic silver salt-containing layer of the photosensitive material of the invention may contain, if desired, a hydrophilic polymer such as gelatin, polyvinyl alcohol, methyl cellulose, hydroxypropyl cellulose or carboxymethyl cellulose.

The amount of the hydrophilic polymer added is preferably 30% by weight or less, more preferably 20% by weight or less, based on the entire binder in the organic silver salt-containing layer.

In the invention, the organic silver salt-containing layer (namely, image-forming layer) is preferably formed using a polymer latex. The amount of the binder in the organic silver salt-containing layer is, in terms of a weight ratio of entire binder/organic silver salt, preferably from 1/10 to 10/1, more preferably from 1/5 to 4/1.

In addition, such an organic silver salt-containing layer usually serves also as a photosensitive layer (emulsion layer) containing a photosensitive silver halide which is a photosensitive silver salt, and in that case, the weight ratio of entire binder/silver halide is preferably from 400 to 5, more preferably from 200 to 10.

According to the invention, the total binder amount of the image-forming layer is preferably from 0.2 to 30 g/m², more preferably from 1 to 15 g/m². The image-forming layer for use in the invention may contain a crosslinking agent for forming a crosslinked structure or a surfactant for improving the coating ability.

In the invention, the solvent (here, for the sake of simplicity, the solvent and the dispersion medium are collectively called a solvent) in the coating solution for the organic silver salt-containing layer of the photosensitive material may be an aqueous solvent containing 30% by weight or more of water. As for the component other than water, an optional water-miscible organic solvent may be used, such as methyl alcohol, ethyl alcohol, isopropyl alcohol, methyl cellosolve, ethyl cellosolve, dimethylformamide and ethyl acetate. The solvent of the coating solution preferably has a water content of 50% by weight or more, more preferably 70% by weight or more.

Examples of preferred solvent compositions include, in addition to water, water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 (the numerals are % by weight).

(Chloride Ion Concentration)

In order to control the chloride ion concentration at 600 ppm or less based on an organic silver salt, it is necessary to reduce chloride ion concentration in the chemicals to be added to the heat-developable photosensitive material. Particularly, it is necessary to strictly control chloride ion concentrations of the components such as solvent, binder, organic silver salt and reducing agent which are used in large amounts.

According to the heat-developable photosensitive material of the invention, the chloride ion concentration in entire layer of the photosensitive layer-containing side of the support is 600 ppm or less, preferably 400 ppm or less, more preferably 200 ppm or less, particularly preferably 50 ppm or less, based on the weight of the organic silver salt.

According to the heat-developable photosensitive material of the invention, when the binder of photosensitive layer is a polymer latex solution or polyvinyl butyral, chloride ion concentration in the polymer latex solution or polyvinyl butyral is preferably 100 ppm or less, more preferably 50 ppm or less, particularly preferably 20 ppm or less, based on the a polymer latex solution or polyvinyl butyral. When the binder is polyvinyl butyral, 10 ppm or less is most preferable. When this chloride ion concentration based on the weight of organic silver salt exceeds 600 ppm, light fastness of the heat-developable photosensitive material after processing greatly worsens.

(Antifoggant)

Examples of the antifoggant, stabilizer and stabilizer precursor which can be used in the invention include those described in the patents cited in Japanese Patent Laid-Open No. 62899/1998 (paragraph No. 0070) and EP-A-0803764A1 (page 20, line 57 to page 21, line 7), and compounds described in Japanese Patent Laid-Open No. 281637/1997 and Japanese Patent Laid-Open No. 329864/1997.

The antifoggant preferably used in the invention is an organic halide and examples thereof include those disclosed in Japanese Patent Laid-Open No. 65021/1999 (paragraph Nos. 0111 to 0112). In particular, organic halogen compounds represented by formula (P) of Japanese Patent Laid-Open No. 2000-284399, organic polyhalogen compounds represented by formula (II) of Japanese Patent Laid-Open No. 339934/1998 and organic polyhalogen compounds described in Japanese Patent Laid-Open No. 2001-33911 are preferred.

According to the invention, a compound represented by the following formula (H) is desirable as the antifoggant.

Q—(Y)ₙ—C(Z₁)(Z₂)X (H)

In formula (H), Q represents an alkyl group, an aryl group or a heterocyclic group, Y represents a divalent linking group, n represents 0 or 1, Z₁ and Z₂ each represent a halogen atom and X represents a hydrogen atom or an electron-withdrawing group.

In formula (H), Q preferably represents a phenyl group substituted by an electron-withdrawing group having a Hammett substituent constant σp of a positive value. The Hammett substituent constant is described, e.g., in Journal of Medicinal Chemistry, Vol. 16, No. 11, 1207-1216 (1973).

Examples of this electron-withdrawing group include halogen atoms (e.g., fluorine atom (σp value: 0.06), chlorine atom (σp value: 0.23), bromine atom (σp value: 0.23), iodine atom (σp value: 0.18)), trihalomethyl groups (e.g., tribromomethyl (σp value: 0.29), trichloromethyl (σp value: 0.33), trifluoromethyl (σp value: 0.54)), a cyano group (σp value: 0.66), a nitro group (σp value: 0.78), aliphatic, aryl or heterocyclic sulfonyl groups (e.g., methanesulfonyl (σp value: 0.72)), aliphatic, aryl or heterocyclic acyl groups (e.g., acetyl (σp value: 0.50), benzoyl (σp value: 0.43)), alkynyl groups (e.g., C≡CH (σp value: 0.23)), aliphatic, aryl or heterocyclic oxycarbonyl groups (e.g., methoxycarbonyl (σp value: 0.45), phenoxycarbonyl (σp value: 0.44)), a carbamoyl group (σp value: 0.36), a sulfamoyl group (σp value: 0.57), a sulfoxide group, a heterocyclic group and a phosphoryl group.

The σp value is within the range of preferably from 0.2 to 2.0, more preferably from 0.4 to 1.0.

Among these electron-withdrawing groups, preferred are a carbamoyl group, an alkoxycarbonyl group, an alkylsulfonyl group and an alkylphosphoryl group, and most preferred is a carbamoyl group.

X is preferably an electron-withdrawing group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, still more preferably a halogen atom.

Among the halogen atoms, preferred are chlorine atom, bromine atom and iodine atom, more preferred are chlorine atom and bromine atom, and still more preferred is bromine atom.

Y preferably represents —C(═O)—, —SO— or —SO₂—, more preferably —C(═O)— or —SO₂—, still more preferably —SO₂—. The symbol n represents 0 or 1, preferably 1.

Specific examples of the compound of formula (H) are set forth below, though the invention is not limited thereto.

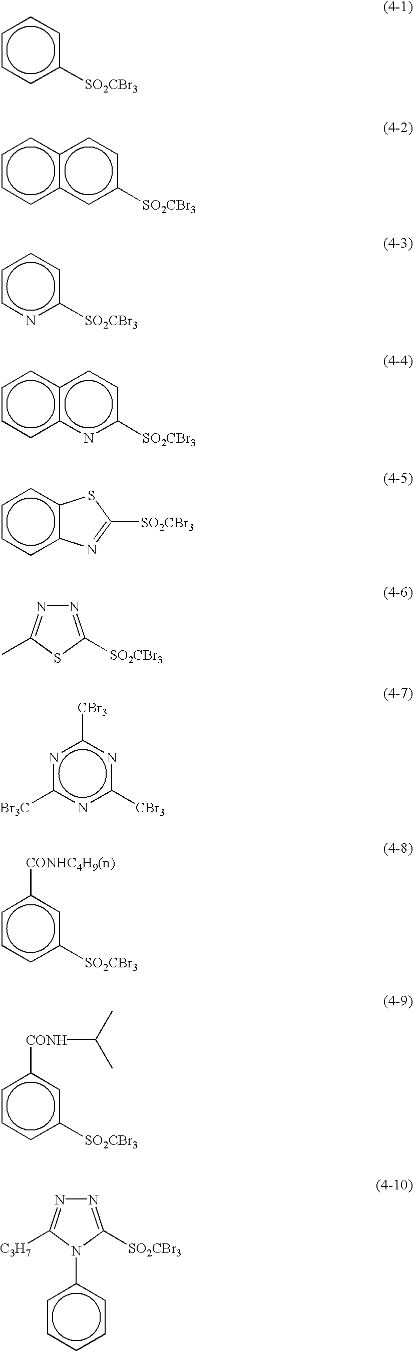

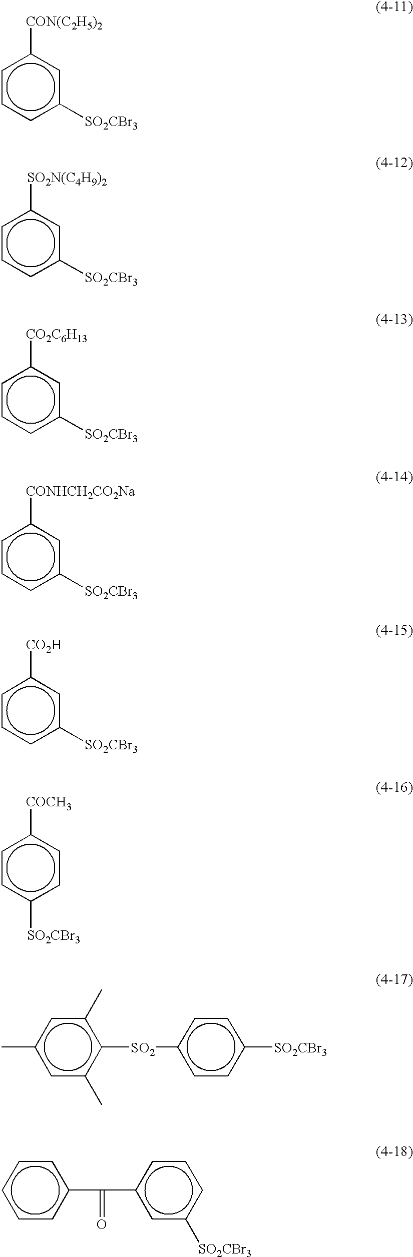

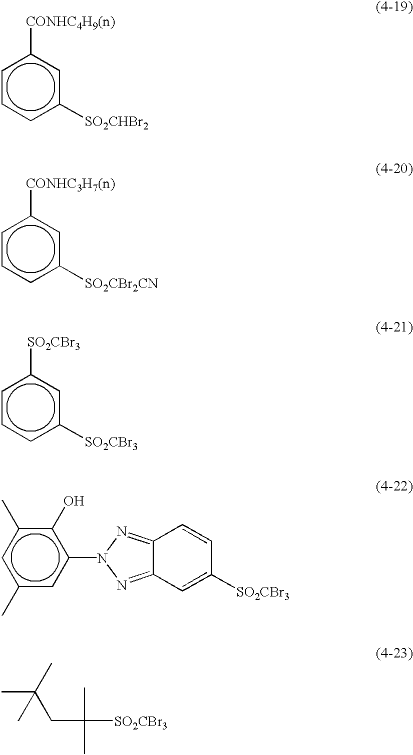

The compound represented by formula (H) is preferably used in the range from 10⁻⁴ to 1 mol, more preferably from 10⁻³ to 0.8 mol, still more preferably from 5×10⁻³ to 0.5 mol, per mol of the non-photosensitive silver salt in the image-forming layer.

According to the invention, for incorporating the compound represented by formula (H) into the photosensitive material, the methods described in the foregoing for the incorporation of the reducing agent may be used.

Melting point of the compound represented by formula (H) is preferably 200° C. or less, more preferably 170° C. or less.

Other examples of the antifoggant include mercury(II) salts described in Japanese Patent Laid-Open No. 65021/1999 (paragraph No. 0113), benzoic acids described in the same patent publication (paragraph No. 0114), salicylic acid derivatives described in Japanese Patent Laid-Open No. 2000-206642, formalin scavenger compounds represented by formula (S) of Japanese Patent Laid-Open No. 2000-221634, triazine compounds according to claim 9 of Japanese Patent Laid-Open No. 352624/1999, compounds represented by formula (III) of Japanese Patent Laid-Open No. 11791/1994, and 4-hydroxy-6-methyl-1,3,3a,7-tetrazaindene.

For the purpose of preventing fogging, the heat-developable photosensitive material of the invention may contain an azolium salt. Examples of the azolium salt include compounds represented by formula (XI) described in Japanese Patent Laid-Open No. 193447/1984, compounds described in Japanese Patent Publication No. 12581/1980, and compounds represented by formula (II) described in Japanese Patent Laid-Open No. 153039/1985. The azolium salt may be added to any site of the photosensitive material but is preferably added to a layer on the side of a photosensitive layer, more preferably to the organic silver salt-containing layer.

The timing of adding azolium salt may be any step during the preparation of the coating solution, and in the case of adding it to the organic silver salt-containing layer, the addition may be made in any step between the preparation of the organic silver salt and the preparation of the coating solution, however, the addition is preferably made between after the preparation of the organic silver salt and immediately before the coating. The azolium salt may be added in any form such as powder, solution or fine grain dispersion. In addition, it may also be added as a mixed solution with other additives such as sensitizing dye, reducing agent and toning agent.

In the invention, the azolium salt may be added in any amount but the amount added is preferably from 1×10⁻⁶ mol to 2 mol, more preferably from 1×10⁻³ mol to 0.5 mol, per mol of silver.

According to the invention, a mercapto compound, a disulfide compound or a thione compound may be incorporated so as to control development by restraining or accelerating the development, enhance the spectral sensitization efficiency or improve the preservability before or after the development, and examples thereof include compounds described in Japanese Patent Laid-Open No. 62899/1998 (paragraph Nos. 0067 to 0069), compounds represented by formula (I) and specific examples thereof in paragraph Nos. 0033 to 0052 of Japanese Patent Laid-Open No. 186572/1998, and compounds described in EP-A-0803764A1 (page 20, lines 36 to 56) and Japanese Patent Laid-Open No. 2001-100358. Among these, mercapto-substituted heteroaromatic compounds are preferred.

(Color Toning Agent)

A color toning agent is preferably added to the heat-developable photosensitive material of the invention, and regarding the color toning agent, combinations of the compound of formula (I) of the invention and phthalic acids (e.g., phthalic acid, 4-methylphthalic acid, 4-nitrophthalic acid, diammonium phthalate, sodium phthalate, potassium phthalate and tetrachlorophthalic anhydride).

The plasticizer and lubricant which can be used in the photosensitive layer of the invention are described in Japanese Patent Laid-Open No. 65021/1999 (paragraph No. 0117), an ultrahigh contrast-providing agent for the formation of an ultrahigh contrast image and addition method or amount added thereof are described in Japanese Patent Laid-Open No. 65021/1999 (paragraph No. 0118), Japanese Patent Laid-Open No. 223898/1999 (paragraph Nos. 0136 to 0193), compounds represented by formula (H), formulae (1) to (3) and formulae (A) and (B)) of Japanese Patent Laid-Open No. 2000-284399, compounds represented by formulae (III) to (V) of Japanese Patent Application No. 91652/1999 (specific compounds: Chem. 21 to Chem. 24), and the contrast-promoting agent is described in Japanese Patent Laid-Open No. 65021/1999 (paragraph No. 0102) and Japanese Patent Laid-Open No. 223898/1999 (paragraph Nos. 0194 to 0195).

In the case of using a formic acid or a formate as a strong foggant, it is preferably contained in an amount of 5 mmol or less, more preferably 1 mmol or less, per mol of silver, on the side of image-forming layer containing a photosensitive silver halide.

In the case where the ultrahigh contrast-providing agent is used in the heat-developable photosensitive material of the invention, an acid resulting from the hydration of diphosphorus pentoxide, or a salt thereof is preferably used in combination. Examples of the acid resulting from the hydration of diphosphorus pentoxide, and salts thereof include metaphosphoric acid (and salts thereof), pyrophosphoric acid (and salts thereof), orthophosphoric acid (and salts thereof), triphosphoric acid (and salts thereof), tetraphosphoric acid (and salts thereof), and hexametaphosphoric acid (and salts thereof).

Examples of the acid resulting from the hydration of diphosphorus pentoxide, or a salt thereof, which are particularly preferably used include orthophosphoric acid (and salts thereof) and hexametaphosphoric acid (and salts thereof). Specific examples of the salts include sodium orthophosphate, sodium dihydrogen orthophosphate, sodium hexametaphosphate and ammonium hexametaphosphate.

The amount used (coated amount per 1 m² of the photosensitive material) of the acid resulting from the hydration of diphosphorus pentoxide, or a salt thereof may be a desired amount in accordance with the properties such as sensitivity and fog, but is preferably from 0.1 to 500 mg/m², more preferably from 0.5 to 100 mg/m².

In the heat-developable photosensitive material of the invention, a surface protective layer may be provided so as to prevent the adhesion of the image-forming layer. The surface protective layer may be a single layer or composed of two or more of layers. The surface protective layer is described in Japanese Patent Laid-Open No. 65021/1999 (paragraph Nos. 0119 to 0120) and Japanese Patent Laid-Open No. 2000-171936.

The binder for the surface protective layer, according to the invention, is preferably gelatin but polyvinyl alcohol (PVA) is also preferably used or used in combination with gelatin. Examples of the gelatin which can be used include inert gelatin (e.g., Nitta Gelatin 750) and phthalated gelatin (e.g., Nitta Gelatin 801).

Examples of PVA include those described in Japanese Patent Laid-Open No. 2000-171936 (paragraph Nos. 0009 to 0020) and preferred examples thereof include completely saponified product PVA-105, partially saponified product PVA-205 and PVA-335, and modified polyvinyl alcohol MP-203 (each trade name, produced by Kuraray Co., Ltd.).

The coated amount (per 1 m² of the support) of polyvinyl alcohol of the protective layer (per one layer) is preferably from 0.3 to 4.0 g/m², more preferably from 0.3 to 2.0 g/m².

Particularly when the heat-developable photosensitive material of the invention is used for printing where the dimensional change becomes a problem, a polymer latex is preferably used for the surface protective layer or the back layer.

The polymer latex is described in “Gosei Jushi Emulsion (Synthetic Resin Emulsion) (edited by Taira Okuda and Hiroshi Inagaki, published by Kobunshi Kankokai (1978))”, “Gosei Latex no Oyo (Application of Synthetic Latex) (edited by Takaaki Sugimura, Yasuo Kataoka, Soichi Suzuki and Keishi Kasahara, published by Kobunshi Kankokai (1993))” and “Gosei Latex no Kagaku (Chemistry of Synthetic Latex) (edited by Soichi Muroi, published by Kobunshi Kankokai (1970))”, and its specific examples include a latex of methyl methacrylate (33.5% by weight)/ethyl acrylate (50% by weight)/methacrylic acid (16.5% by weight) copolymer, a latex of methyl methacrylate (47.5% by weight)/butadiene (47.5% by weight)/itaconic acid (5% by weight) copolymer, a latex of ethyl acrylate/methacrylic acid copolymer, a latex of methyl methacrylate (58.9% by weight)/2-ethylhexyl acrylate (25.4% by weight)/styrene (8.6% by weight)/2-hydroxyethyl methacrylate (5.1% by weight)/acrylic acid (2.0% by weight) copolymer and a latex of methyl methacrylate (64.0% by weight)/styrene (9.0% by weight)/butyl acrylate (20.0% by weight)/2-hydroxyethyl methacrylate (5.0% by weight)/acrylic acid (2.0% by weight) copolymer.

In addition, for the binder of the surface protective layer, the techniques described in Japanese Patent Laid-Open No. 2000-267226 (paragraph Nos. 0021 to 0025) and Japanese Patent Laid-Open No. 2000-19678 (paragraph Nos. 0023 to 0041) may also be applied. The percentage of the polymer latex in the surface protective layer is preferably from 10 to 90% by weight, more preferably from 20 to 80% by weight, based on the entire binder.

The coated amount (per m² of the support) of the entire binder (including water-soluble polymer and latex polymer) for the surface protective layer (per one layer) is preferably from 0.3 to 5.0 g/m², more preferably from 0.3 to 2.0 g/m².

According to the invention, the temperature at the preparation of a coating solution for the image-forming layer is preferably from 30 to 65° C., more preferably from 35 to less than 60° C., still more preferably from 35 to 55° C. Furthermore, it is desirable that the coating solution for the image-forming layer immediately after the addition of the polymer latex is kept at a temperature of from 30 to 65° C.

According to the invention, the image-forming layer is composed of one or more layers arranged on the support. In the case where it is composed of a single layer, the layer comprises an organic silver salt, a photosensitive silver halide, a reducing agent and a binder and if desired, additionally contains desired materials such as a color toning agent, a coating aid and other adjuvants.

In the case where the image-forming layer is composed of two or more layers, a first image-forming layer (usually a layer adjacent to the support) contains an organic silver salt and a photosensitive silver halide, and a second image-forming layer or these two layers contain some other components. In the structure of a multicolor photosensitive heat-developable photographic material, a combination of these two layers may be provided for each color or all the components may be contained in a single layer as described in U.S. Pat. No. 4,708,928.

In the case of a multi-dye multicolor photosensitive heat-developable photographic material, the emulsion layers are held separated from each other by interposing a functional or nonfunctional barrier layer between respective photosensitive layers, as described in U.S. Pat. No. 4,460,681.

The photosensitive layer of the invention may contain various dyes or pigments (for example, C.I. Pigment Blue 60, C.I. Pigment Blue 64, C.I. Pigment Blue 15:6) from the standpoint of improving the tone, inhibiting the generation of interference fringes on laser exposure or preventing the irradiation. These are described in detail in WO98/36322, Japanese Patent Laid-Open No. 268465/1998 and Japanese Patent Laid-Open No. 338098/1999.

In the heat-developable photosensitive material of the invention, an antihalation layer can be provided on the side farther from a light source with respect to the photosensitive layer.

The heat-developable photosensitive material generally has a non-photosensitive layer in addition to the photosensitive layer. The non-photosensitive layer can be classified by its position, into (1) a protective layer provided on a photosensitive layer (on the side farther from the support), (2) an interlayer provided between two or more of photosensitive layers or between a photosensitive layer and a protective layer, (3) an undercoat layer provided between a photosensitive layer and a support, and (4) a back layer provided on the side opposite the photosensitive layer.

In the photosensitive material, a filter layer is provided as the layer (1) or (2). An antihalation layer is provided as the layer (3) or (4) in the photosensitive material.

The antihalation layer is described in Japanese Patent Laid-Open No. 65021/1999 (paragraph Nos. 0123 to 0124), Japanese Patent Laid-Open No. 223898/1999, Japanese Patent Laid-Open No. 230531/1997, Japanese Patent Laid-Open No. 36695/1998, Japanese Patent Laid-Open No. 1047791998, Japanese Patent Laid-Open No. 231457/1999, Japanese Patent Laid-Open No. 352625/1999 and Japanese Patent Laid-Open No. 352626/1999.

The antihalation layer contains an antihalation dye having absorption at the exposure wavelength. In the case where the exposure wavelength is present in the infrared region, an infrared ray-absorbing dye is used and in this case, the dye preferably has no absorption in the visible region.

In the case of preventing the halation using a dye having absorption in the visible region, it is preferred to allow substantially no color of the dye to remain after the formation of an image, means capable of decolorizing under the action of heat at the heat development is preferably used, and the non-photosensitive layer is preferably rendered to function as an antihalation layer by adding thereto a thermally decolorizable dye and a base precursor. Japanese Patent Laid-Open No. 231457/1999 describes these techniques.

The amount of the decolorizable dye is determined according to the use purpose of the dye. In general, the decolorizable dye is used in an amount of giving an optical density (absorbance) in excess of 0.1 when measured at the objective wavelength. The optical density is preferably from 0.2 to 2. For attaining such an optical density, the amount of the dye used is generally on the order of 0.001 to 1 g/m².

In this connection, by such decolorization of a dye, the optical density after heat development can be reduced to 0.1 or less. Two or more decolorizable dyes may be used in combination with the thermally decolorizable recording material or heat-developable photosensitive material. Also, two or more base precursors may be used in combination.

In the thermal decolorization using these decolorizable dye and base precursor, a substance (e.g., diphenylsulfone, 4-chlorophenyl(phenyl)sulfone) capable of lowering the melting point by 3° C. or more when mixed with the base precursor, described in Japanese Patent Laid-Open No. 352626/1999, is preferably used in combination in view of certain properties such as the thermal decolorizability.

According to the invention, a coloring agent having an absorption maximum at 300 to 450 nm can be added for the purpose of improving silver tone or change of image in aging. Examples of such a coloring agent include those described in Japanese Patent Laid-Open No. 210458/1987, Japanese Patent Laid-Open No. 104046/1988, Japanese Patent Laid-Open No. 103235/1988, Japanese Patent Laid-Open No. 208846/1988, Japanese Patent Laid-Open No. 306436/1988, Japanese Patent Laid-Open No. 314535/1988, Japanese Patent Laid-Open No. 61745/1989 and Japanese Patent Laid-Open No. 2001-100363.

The coloring agent is usually added in the range of from 0.1 mg/m² to 1 g/m² and the layer to which the coloring agent is added is preferably a back layer provided on the side opposite the photosensitive layer.

The heat-developable photosensitive material of the invention is preferably a so-called one-side photosensitive material having at least one photosensitive layer containing a silver halide emulsion on one side of the support and having a back layer on the other side.

According to the invention, a matting agent is preferably added for improving the conveyance property, and examples of the matting agent include those described in Japanese Patent Laid-Open No. 65021/1999 (paragraph Nos. 0126 to 0127).

The amount of the matting agent added is, in terms of the coated amount per 1 m² of the photosensitive material, preferably from 1 to 400 mg/m², more preferably from 5 to 300 mg/m².

The matting degree on the emulsion surface may be any value insofar as a stardust failure does not occur, but is preferably, in terms of the Bekk smoothness, from 30 to 2,000 seconds, more preferably from 40 to 1,500 seconds. The Bekk smoothness can be easily determined according to Japanese Industrial Standard (JIS) P8119, “Test Method for Smoothness of Paper and Paperboard by Bekk Tester” and TAPPI Standard Method T479.

As for the matting degree of the back layer for use in the invention, the Bekk smoothness is preferably from 10 to 1,200 seconds, more preferably from 20 to 800 seconds, still more preferably from 40 to 500 seconds.

According to the invention, the matting agent is preferably incorporated into the outermost surface layer, a layer acting as the outermost surface layer, or a layer close to the outer surface, of the photosensitive material, or is preferably incorporated into a layer acting as a protective layer.

The back layer which can be applied to the invention is described in Japanese Patent Laid-Open No. 65021/1999 (paragraph Nos. 0128 to 0130).

According to the invention, the pH on the layer surface of the heat-developable photosensitive layer before heat development is preferably 7.0 or less, more preferably 6.6 or less. The lower limit thereof is not particularly limited but is about 3. The most preferred pH range is from 4 to 6.2.

For adjusting the pH on the layer surface, a nonvolatile acid such as organic acid (e.g., phthalic acid derivative) or sulfuric acid, or a volatile base such as ammonia is preferably used from the standpoint of reducing the pH on the layer surface. In particular, ammonia is preferred for achieving a low layer surface pH, because ammonia is readily volatilized and can be removed before the coating step or the heat development. Furthermore, a combined use of ammonia with a nonvolatile base such as sodium hydroxide, potassium hydroxide or lithium hydroxide is also preferred. In this connection, the method of measuring the pH on the layer surface is described in Japanese Patent Laid-Open No. 2000-284399 (paragraph No. 0123).

In the invention, a hardening agent may be used for each of the layers such as photosensitive layer, protective layer and back layer.

Examples of the hardening agent include those described in “The Theory of the Photographic Process Fourth Edition” edited by T. H. James (Macmillan Publishing Co., Inc. (1977)) pp. 77-87, and chrome alum, 2,4-dichloro-6-hydroxy-s-triazine sodium salt, N,N-ethylenebis(vinylsulfonacetamide) and N,N-propylenebis(vinylsulfonacetamide), as well as polyvalent metal ion described in the same document, page 78, polyisocyanates described in U.S. Pat. No. 4,281,060 and Japanese Patent Laid-Open No. 208193/1994, epoxy compounds described in U.S. Pat. No. 4,791,042, and vinyl sulfone-base compounds described in Japanese Patent Laid-Open No. 89048/1987 can be preferably used.

The hardening agent is added as a solution, and the timing of adding this solution to the coating solution for protective layer is from 180 minutes before coating to immediately before coating, preferably from 60 minutes to 10 seconds before coating, but the mixing method and conditions for the mixing are not particularly limited insofar as the effect of the invention is satisfactorily brought out.

Specific examples of the mixing method include a method of mixing the solutions in a tank designed to give a desired average residence time which is calculated from the addition flow rate and the liquid transfer amount to the coater, and a method using a static mixer described in Chap. 8 of “Ekitai Kongo Gijutsu (Liquid Mixing Technique)”, edited by N. Harnby, M. F. Edwards and A. W. Nienow (translated by Koji Takahashi), (Nikkan Kogyo Shinbun Sha ,1989).

The surface active agent which can be applied to the invention is described in Japanese Patent Laid-Open No. 65021/1999 (paragraph No. 0132), the solvent is described in paragraph No. 0133 of the same document, the support is described in paragraph No. 0134 of the same, the antistatic or electrically conducting layer is described in paragraph No. 0135 of the same, the method for obtaining a color image is described in paragraph No. 0136 of the same, and the slipping agent is described in Japanese Patent Laid-Open No. 84573/1999 (paragraph Nos. 0061 to 0064).

The transparent support is preferably polyester, particularly polyethylene terephthalate, subjected to a heat treatment in the temperature range from 130 to 185° C. so as to relax the internal distortion remaining in the film during the biaxial stretching and thereby eliminate the occurrence of thermal shrinkage distortion during the heat development.

In the case of a heat-developable photosensitive material for medical uses, the transparent support may be colored with a bluish dye (e.g., Dye-1 described in Example of Japanese Patent Laid-Open No. 240877/1996) or may be colorless.

For the support, an undercoat technique of, e.g., undercoating a water-soluble polyester described in Japanese Patent Laid-Open No. 84574/1999, a styrene-butadiene copolymer described in Japanese Patent Laid-Open No. 186565/1998, or a vinylidene chloride copolymer described in Japanese Patent Laid-Open No. 2000-39684 is preferably applied.

Also, as for the antistatic layer or undercoat, techniques described in Japanese Patent Laid-Open No. 143430/1981, Japanese Patent Laid-Open No. 143431/1981, Japanese Patent Laid-Open No. 62646/1983, Japanese Patent Laid-Open No. 120519/1981, Japanese Patent Laid-Open No. 84573/1999 (paragraph Nos. 0040 to 0051), U.S. Pat. No. 5,575,957 and Japanese Patent Laid-Open No. 223898/1999 (paragraph Nos. 0078 to 0084) can be applied.

The heat-developable photosensitive material is preferably a mono-sheet type (a type where an image can be formed on the heat-developable photosensitive material without using another sheet such as image-receiving material).

The heat-developable photosensitive material may further contain an antioxidant, a stabilizer, a plasticizer, an ultraviolet absorber or a coating aid. These various additives are added to either a photosensitive layer or a non-photosensitive layer. These additives are described in WO 98/36322, EP-A-803764A1, Japanese Patent Laid-Open No. 186567/1998 and Japanese Patent Laid-Open No. 18568/1998.

The heat-developable photosensitive material of the invention may be coated in any manner. To speak specifically, various coating operations including extrusion coating, slide coating, curtain coating, dip coating, knife coating, flow coating, and extrusion coating using a hopper of the type described in U.S. Pat. No. 2,681,294 may be used, and the extrusion coating or slide coating described in “LIQUID FILM COATING”, edited by Stephen F. Kistler and Petert M. Schweizer, pp. 399-536, (published by CHAPMAN & HALL ,1977) is preferred, in particular, the slide coating is more preferred.

An example of the shape of the slide coater used in the slide coating is shown in Fig. 11b.1, page 427 of the above-described document. If desired, two or more layers may be simultaneously coated using a method described in the above-described document, pp. 399-536, U.S. Pat. No. 2,761,791 and British Patent No. 837,095.

The coating solution for the organic silver salt-containing layer used in the invention is preferably a so-called thixotropic fluid. This technique is described in Japanese Patent Laid-Open No. 52509/1999.

The coating solution for the organic silver salt-containing layer used in the invention preferably has a viscosity of 400 to 100,000 mPa·s, more preferably from 500 to 20,000 mPa·s, at a shear rate of 0.1 S⁻¹.

At a shear rate of 1,000 S⁻¹, the viscosity is preferably from 1 to 200 mPa·s, more preferably from 5 to 80 mPa·s.

Examples of the technique which can be used in the heat-developable photosensitive material of the invention include those described in EP-A-803764A1, EP-A-883022A1, WO 98/36322, Japanese Patent Laid-Open No. 62648/1981, Japanese Patent Laid-Open No. 62644/1982, Japanese Patent Laid-Open No. 43766/1997, Japanese Patent Laid-Open No. 281637/1997, Japanese Patent Laid-Open No. 297367/1997, Japanese Patent Laid-Open No. 304869/1997, Japanese Patent Laid-Open No. 311405/1997, Japanese Patent Laid-Open No. 329865/1997, Japanese Patent Laid-Open No. 10669/1998, Japanese Patent Laid-Open No. 62899/1998, Japanese Patent Laid-Open No. 69023/1998, Japanese Patent Laid-Open No. 186568/1998, Japanese Patent Laid-Open No. 90823/1998, Japanese Patent Laid-Open No. 171063/1998, Japanese Patent Laid-Open No. 186565/1998, Japanese Patent Laid-Open No. 186567/1998, Japanese Patent Laid-Open No. 186569/1998 to Japanese Patent Laid-Open No. 186572/1998, Japanese Patent Laid-Open No. 197974/1998, Japanese Patent Laid-Open No. 197982/1998, Japanese Patent Laid-Open No. 197983/1998, Japanese Patent Laid-Open No. 197985/1998 to Japanese Patent Laid-Open No. 197987/1998, Japanese Patent Laid-Open No. 207001/1998, Japanese Patent Laid-Open No. 207004/1998, Japanese Patent Laid-Open No. 221807/1998, Japanese Patent Laid-Open No. 282601/1998, Japanese Patent Laid-Open No. 288823/1998, Japanese Patent Laid-Open No. 288824/1998, Japanese Patent Laid-Open No. 307365/1998, Japanese Patent Laid-Open No. 312038/1998, Japanese Patent Laid-Open No. 339934/1998, Japanese Patent Laid-Open No. 7100/1999, Japanese Patent Laid-Open No. 15105/1999, Japanese Patent Laid-Open No. 24200/1999, Japanese Patent Laid-Open No. 24201/1999, Japanese Patent Laid-Open No. 30832/1999, Japanese Patent Laid-Open No. 84574/1999, Japanese Patent Laid-Open No. 65021/1999, Japanese Patent Laid-Open No. 109547/1999, Japanese Patent Laid-Open No. 125880/1999, Japanese Patent Laid-Open No. 129629/1999, Japanese Patent Laid-Open No. 133536/1999 to Japanese Patent Laid-Open No. 133539/1999, Japanese Patent Laid-Open No. 133542/1999, Japanese Patent Laid-Open No. 133543/1999, Japanese Patent Laid-Open No. 223898/1999, Japanese Patent Laid-Open No. 352627/1999, Japanese Patent Laid-Open No. 305377/1999, Japanese Patent Laid-Open No. 305378/1999, Japanese Patent Laid-Open No. 305384/1999, Japanese Patent Laid-Open No. 305380/1999, Japanese Patent Laid-Open No. 316435/1999, Japanese Patent Laid-Open No. 327076/1999, Japanese Patent Laid-Open No. 338096/1999, Japanese Patent Laid-Open No. 338098/1999, Japanese Patent Laid-Open No. 338099/1999, Japanese Patent Laid-Open No. 343420/1999, Japanese Patent Laid-Open No. 2000-187298, Japanese Patent Laid-Open No. 2000-10229, Japanese Patent Laid-Open No. 2000-47345, Japanese Patent Laid-Open No. 2000-206642, Japanese Patent Laid-Open No. 2000-98530, Japanese Patent Laid-Open No. 2000-98531, Japanese Patent Laid-Open No. 2000-112059, Japanese Patent Laid-Open No. 2000-112060, Japanese Patent Laid-Open No. 2000-112104, Japanese Patent Laid-Open No. 2000-112064 and Japanese Patent Laid-Open No. 2000-171936.

The heat-developable photosensitive material of the invention may be developed by any method but the development is usually carried out by raising the temperature of an imagewise exposed heat-developable photosensitive material. The development temperature is preferably from 80 to 250° C., more preferably from 100 to 140° C.

The development time is preferably from 1 to 60 seconds, more preferably from 3 to 30 seconds, still more preferably from 5 to 20 seconds, particularly preferably from 10 to 15 seconds.

As the heat development system, a plate heater system is preferred. The heat development system using the plate heater is preferably a system described in Japanese Patent Laid-Open No. 1335721/1999, which is a heat developing apparatus of obtaining a visible image by bringing a heat-developable photosensitive material having formed thereon a latent image into contact with heating means in the heat-developing section, wherein the heating means comprises a plate heater, two or more of press rollers are disposed to face each other along one surface of the plate heater, and the heat-developable photosensitive material is passed between the press rollers and the plate heater, thereby performing the heat development. The plate heater is preferably divided into 2 to 6 stages and the temperature at the first stage is preferably lowered by approximately from 1 to 10° C.

Such a method is described also in Japanese Patent Laid-Open No. 30032/1979, where the water or organic solvent contained in the heat-developable photosensitive material can be excluded out of the system and the heat-developable photosensitive material can be prevented from change in the shape of the support, which is otherwise caused by abrupt heating of the heat-developable photosensitive layer.

Any method may be used for exposing the photosensitive material of the invention, but laser beam is preferable as the exposure light source. The laser beam for use in the invention is preferably a gas laser, a YAG laser, a dye laser or a semiconductor laser. Also, a semiconductor laser combined with a second harmonic generating device may be used.

The heat-developable photosensitive material of the invention forms a black-and-white image by the silver image and is preferably used as a heat-developable photosensitive material for medical diagnosis, a heat-developable photosensitive material for industrial photography, a heat-developable photosensitive material for printing or a heat-developable photosensitive material for COM.

The invention is described in greater detail below by referring to Examples, however, it should be understood that the invention is not limited thereto.

### EXAMPLE 1

(Preparation of PET Support)

PET having an intrinsic viscosity IV of 0.66 (measured at 25° C. in phenol/tetrachloroethane=6/4 (weight ratio)) was obtained in a usual manner using terephthalic acid and ethylene glycol. This was pelletized and the pellets obtained were dried at 130° C. for 4 hours, melted at 300° C., extruded from a T-die and then rapidly cooled to prepare an un-stretched film having a thickness large enough to give a thickness of 175 μm after the heat setting.

This film was stretched to 3.3 times in the machine direction using rolls different in the peripheral speed and then stretched to 4.5 times in the cross direction by a tenter. At this time, the temperatures were 110° C. and 130° C., respectively. Subsequently, the film was heat set at 240° C. for 20 seconds and relaxed by 4% in the cross direction at the same temperature. Thereafter, the chuck part of the tenter was slit, both edges of the film were knurled, and the film was taken up at 4 kg/cm² to obtain a roll having a thickness of 175 μm.

(Surface Corona Treatment)

Both surfaces of the support were treated at room temperature at 20 m/min using a solid state corona treating machine “Model 6KVA” manufactured by Pillar Technologies. From the current and voltage read at this time, it was known that a treatment of 0.375 kV·A·min/m² was applied to the support. The treatment frequency here was 9.6 kHz and the gap clearance between the electrode and the dielectric roll was 1.6 mm.

(Preparation of Undercoated Support)
(1) Preparation of Coating Solution for Undercoat Layer
Formulation (1) (for undercoat layer on the photosensitive layer
side)

| | | |
|---|---|---|
| PESRESIN A-520 (30% by weight solution) | 59 | g |
| produced by Takamatsu Yushi K.K. | | |
| Polyethylene glycol monononylphenyl ether | 5.4 | g |
| (average ethylene oxide number = 8.5), 10% by | | |
| weight solution | | |
| MP-1000 (fine polymer particles, average | 0.91 | g |
| particle size 0.4 μm) produced by Soken Kagaku | | |
| K. K. | | |
| Distilled water | 935 | ml |

Formulation (2) (for first layer on the back surface)

| | | |
|---|---|---|
| Styrene/butadiene copolymer latex (solid | 158 | g |
| content 40% by weight, styrene/butadiene | | |
| weight ratio 68/32) | | |
| 2,4-Dichloro-6-hydroxy-S-triazine sodium | 20 | g |
| salt, 8% by weight aqueous solution | | |
| 1% by weight aqueous solution of sodium | 10 | ml |
| laurylbenzenesulfonate | | |
| Distilled water | 854 | ml |

Formulation (3) (for second layer on the back surface)

| | | |
|---|---|---|
| SnO₂/SbO (9/1 by weight, average particle size | 84 | g |
| 0.038 μm, 17% by weight dispersion) | | |
| Gelatin (10% by weight aqueous solution) | 89.2 | g |
| METROSE TC-5 (2% by weight aqueous solution) | 8.6 | g |
| produced by Shin-Etsu Chemical Co., Ltd. | | |
| MP-1000 produced by Soken Kagaku K.K. | 0.01 | g |
| 1% by weight aqueous solution of sodium | 10 | ml |
| dodecylbenzenesulfonate | | |
| NaOH (1% by weight) | 6 | ml |
| PROXEL (produced by ICI) | 1 | ml |
| Distilled water | 805 | ml |

Each of both surfaces of the 175 μm-thick biaxially stretched polyethylene terephthalate support was subjected to the corona discharge treatment, and then, the undercoating solution of formulation (1) was applied on one surface (photosensitive layer surface) by a wire bar to have a wet coated amount of 6.6 ml/m² (per one surface) and dried at 180° C. for 5 minutes, the undercoating solution of formulation (2) was applied on the opposite surface thereof (back surface) by a wire bar to have a wet coated amount of 5.7 ml/m² and dried at 180° C. for 5 minutes, and the undercoating solution of formulation (3) was further applied on the opposite surface (back surface) by a wire bar to have a wet coated amount of 7.7 ml/m² and dried at 180° C. for 6 minutes, thereby obtaining an undercoated support.

(Preparation of Coating Solution for Back Surface)

(Preparation of Solid Fine Particle Dispersion (a) of Base Precursor)

A 64 g portion of Base Precursor Compound 1, 28 g of diphenylsulfone and 10 g of a surfactant Demol N (produced by Kao Corporation) were mixed with 220 ml of distilled water, and the mixed solution was dispersed using beads in a sand mill (¼ Gallon Sand Grinder Mill, manufactured by AIMEX K.K.) to obtain Solid Fine Particle Dispersion (a) of Base Precursor Compound, having an average particle size of 0.2 μm.

(Preparation of Solid Fine Particle Dispersion of Dye)

A 19.2 g portion of Cyanine Dye Compound 1, 9.6 g of sodium p-dodecylbenzenesulfonate and 1.92 g of a surfactant Demol SNB (produced by Kao Corporation) were mixed with 289 ml of distilled water and the mixed solution was dispersed using 0.5 mm zirconia beads in a sand mill (¼ Gallon Sand Grinder Mill, manufactured by AIMEX K.K.) to obtain a solid fine particle dispersion of dye, having an average particle size of 0.2 μm.

(Preparation of Coating Solution for Antihalation Layer)

A 17 g portion of gelatin, 9.6 g of polyacrylamide, 56 g of the Solid Fine Particle Dispersion (a) of Base Precursor, 25 g of the solid fine particle dispersion of dye, 1.5 g of monodisperse polymethyl methacrylate fine particles (average particle size: 8 μm, standard deviation of particle size: 0.4), 0.03 g of benzoisothiazolinone, 2.2 g of sodium polyethylenesulfonate, 0.1 g of Blue Dye Compound 1, 0.1 g of Yellow Dye Compound 1 and 869 ml of water were mixed to prepare a coating solution for antihalation layer.

(Preparation of Coating Solution for Protective Layer on Back Surface)

In a container kept at 40° C., 50 g of gelatin, 0.2 g of sodium polystyrenesulfonate, 2.4 g of N,N-ethylenebis(vinylsulfonacetamide), 1 g of sodium t-octylphenoxyethoxyethanesulfonate, 30 mg of benzoisothiazolinone, 37 mg of a fluorine-containing surfactant (F-1: N-perfluorooctylsulfonyl-N-propylalanine potassium salt), 150 mg of a fluorine-containing surfactant (F-2: polyethylene glycol mono(N-perfluorooctylsulfonyl-N-propyl-2-aminoethyl) ether [ethylene oxide average polymerization degree: 15]), 64 mg of a fluorine-containing surfactant (F-3), 32 mg of a fluorine-containing surfactant (F-4), 8.8 g of an acrylic acid/ethyl acrylate copolymer (copolymerization weight ratio: 5/95), 0.6 g of Aerosol OT (produced by American Cyanamide), 1.8 g of liquid paraffin emulsion as liquid paraffin and 950 ml of water were mixed to prepare a coating solution for protective layer on the back surface.

(Preparation of Silver Halide Emulsion)

<Preparation of Silver Halide Emulsion 1>

A solution was prepared by adding 3.1 ml of a 1% by weight potassium bromide solution, 3.5 ml of sulfuric acid in a concentration of 0.5 mol/L and 31.7 g of phthalated gelatin to 1,421 ml of distilled water and while stirring the solution in a stainless steel-made reaction pot and keeping the liquid temperature at 30° C., the entire amount of Solution A prepared by diluting 22.22 g of silver nitrate with distilled water to a volume of 95.4 ml and the entire amount of Solution B prepared by diluting 15.3 g of potassium bromide and 0.8 g of potassium iodide with distilled water to a volume of 97.4 ml were added at a constant flow rate over 45 seconds. Thereto, 10 ml of an aqueous 3.5% by weight hydrogen peroxide solution was added and then, 10.8 ml of a 10% by weight aqueous solution of benzimidazole was further added. Thereafter, Solution C prepared by diluting 51.86 g of silver nitrate with distilled water to a volume of 317.5 ml and Solution D obtained by diluting 44.2 g of potassium bromide and 2.2 g of potassium iodide with distilled water to a volume of 400 ml were added, wherein the entire amount of Solution C was added at a constant flow rate over 20 minutes and Solution D was added by the controlled double jet method while maintaining the pAg at 8.1. Ten minutes after the initiation of addition of Solution C and Solution D, the entire amount of potassium hexachloroiridate(III) was added to a concentration of 1×10⁻⁴ mol per mol of silver. Furthermore, 5 seconds after the completion of addition of Solution C, the entire amount of an aqueous potassium hexacyanoferrate(II) solution was added to a concentration of 3×10⁻⁴ mol per mol of silver. Then, the pH was adjusted to 3.8 using sulfuric acid in a concentration of 0.5 mol/L and after stirring was stopped, the resulting solution was subjected to precipitation/desalting/water washing. The pH was then adjusted to 5.9 using sodium hydroxide in a concentration of 1 mol/L, thereby preparing a silver halide dispersion at a pAg of 8.0.

While stirring the silver halide dispersion and keeping it at 38° C., 5 ml of a methanol solution containing 0.34% by weight of 1,2-benzoisothiazolin-3-one was added and after 40 minutes, a methanol solution containing Spectral Sensitizing Dye A and Spectral Sensitizing Dye B at a molar ratio of 1:1 was added in an amount, as a total of Sensitizing Dye A and Sensitizing Dye B, of 1.2×10⁻³ mol per mol of silver. After 1 minute, the temperature was elevated to 47° C. and 20 minutes after the elevation of temperature, a methanol solution of sodium benzenethiosulfonate was added in an amount of 7.6×10⁻⁵ mol per mol of silver. After 5 minutes, a methanol solution of Tellurium Sensitizer C was further added in an amount of 2.9×10⁻⁴ mol per mol of silver and then, the solution was ripened for 91 minutes. Thereto, 1.3 ml of a 0.8% by weight methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 4.8×10⁻³ mol and 5.4×10⁻³ mol, respectively, per mol of silver to prepare Silver Halide Emulsion 1.

The grains in the thus prepared silver halide emulsion were silver iodobromide grains having an average equivalent-sphere diameter of 0.042 μm and a coefficient of variation in the equivalent-sphere diameter of 20% and uniformly containing 3.5% by mol of iodide. The grain size and other values were determined as an average of 1,000 grains using an electron microscope. The percentage of [100] faces in the grain was 80% as determined using the Kubelka-Munk equation.

<Preparation of Silver Halide Emulsion 2>

Silver Halide Emulsion 2 was prepared in the same manner as in the preparation of Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide with distilled water to a volume of 400 ml, the addition time of Solution C was changed to 30 minutes and potassium hexacyanoferrate(II) was excluded. Also, the precipitation/desalting/water washing/dispersion were performed in the same manner as in the preparation of Silver Halide Emulsion 1. Thereafter, the spectral sensitization, chemical sensitization and addition of 5-methyl-2-mercaptobenzimidazole and 1-phenyl-2-heptyl-5-mercapto-1,3,4-triazole were performed in the same manner as in the preparation of Emulsion 1 except that the amount added of the methanol solution containing Spectral Sensitizing Dye A and Spectral Sensitizing Dye B at a molar ratio of 1:1 was changed, as a total of Sensitizing Dye A and Sensitizing Dye B, to 7.5×10⁻⁴ mol per mol of silver, the amount of Tellurium Sensitizer B added was changed to 1.1×10⁻⁴ mol per mol of silver, and the amount of 1-phenyl-2-heptyl-5-mercapto-1,3,4-triazole added was changed to 3.3×10⁻³ mol per mol of silver, thereby obtaining Silver Halide Emulsion 2. The emulsion grains of Silver Halide Emulsion 2 were pure silver bromide cubic grains having an average equivalent-sphere diameter of 0.080 μm and a coefficient of variation in the equivalent-sphere diameter of 20%

<Preparation of Silver Halide Emulsion 3>

Silver Halide Emulsion 3 was prepared in the same manner as in the preparation of Silver Halide Emulsion 1 except that the liquid temperature at the grain formation was changed from 30° C. to 27° C. Also, the precipitation/desalting/water washing/dispersion were performed in the same manner as in the preparation of Silver Halide Emulsion 1. Thereafter, Silver Halide Emulsion 3 was obtained in the same manner as Emulsion 1 except that a solid dispersion (aqueous gelatin solution) containing Spectral Sensitizing Dye A and Spectral Sensitizing Dye B at a molar ratio of 1:1 was added in an amount, as a total of Sensitizing Dye A and Sensitizing Dye B, of 6×10⁻³ mol per mol of silver, and the amount of Tellurium Sensitizer B added was changed to 5.2×10⁻⁴ mol per mol of silver. The emulsion grains of Silver Halide Emulsion 3 were silver iodobromide grains having an average equivalent-sphere diameter of 0.034 μm and a coefficient of variation in the equivalent-sphere diameter of 20% and uniformly containing 3.5% by mol of iodide.

<Preparation of Mixed Emulsion A for Coating Solution>

A 70% by weight portion of Silver Halide Emulsion 1, 15% by weight of Silver Halide Emulsion2 and 15% by weight of Silver Halide Emulsion 3 were dissolved, and a 1% by weight aqueous solution of benzothiazolium iodide was added thereto in an amount of 7×10⁻³ mol per mol of silver. Furthermore, water was added to adjust the silver halide content to 38.2 g in terms of silver per kg of the mixed emulsion for coating solution.

<Preparation of Fatty Acid Silver Salt Dispersion>

A 87.6 kg portion of behenic acid (Edenor C22-85R, trade name, produced by Henkel Co.), 423 L of distilled water, 49.2 L of an aqueous NaOH solution in a concentration of 5 mol/L and 120 L of t-butyl alcohol were mixed and allowed to undergo the reaction by stirring at 75° C. for one hour to obtain a sodium behenate solution. Separately, 206.2 L (pH 4.0) of an aqueous solution containing 40.4 kg of silver nitrate was prepared and kept at 10° C. A reactor containing 635 L of distilled water and 30 L of t-butyl alcohol was kept at 30° C. and while thoroughly stirring, the entire amount of the sodium behenate solution and the entire amount of the aqueous silver nitrate solution were added at constant flow rates over the period of 93 minutes and 15 seconds and the period of 90 minutes, respectively. At this time, only the aqueous silver nitrate solution was added for the period of 11 minutes after the initiation of addition of the aqueous silver nitrate solution, then addition of the sodium behenate solution was started, and only the sodium behenate solution was added for the period of 14 minutes and 15 seconds after the completion of addition of the aqueous silver nitrate solution. During the addition, the temperature inside the reactor was kept at 30° C. and the outer temperature was controlled to make constant the liquid temperature. The piping in the system of adding the sodium behenate solution was kept warm by circulating hot water in the outer side of a double pipe, whereby the outlet liquid temperature at the outlet of the addition nozzle was adjusted to 75° C. Also, the piping in the system of adding the aqueous silver nitrate solution was kept warm by circulating cold water in the outer side of a double pipe. The addition site of sodium behenate solution and the addition site of aqueous silver nitrate solution were symmetrically arranged centered around the stirring axis, and these addition sites were each adjusted to a height of not causing contact with the reaction solution.

After the completion of addition of the sodium behenate solution, the mixture was left at that temperature for 20 minutes with stirring, the temperature was then elevated to 35° C. over 30 minutes, and the solution was ripened for 210 minutes. Immediately after the completion of ripening, the solid content was separated by centrifugal filtration and washed with water until the conductivity of filtrate became 30 μS/cm. In this manner, a fatty acid silver salt was obtained. The solid content obtained was not dried but stored as a wet cake.

When the shape of the thus obtained silver behenate grains was analyzed by an electron microphotography, the grains were scaly crystals having average sizes of a=0.14 μm, b=0.4 μm and c=0.6 μm, an average aspect ratio of 5.2, an average equivalent-sphere diameter of 0.52 μm and a coefficient of variation in the equivalent-sphere diameter of 15% (a, b and c comply with the definition in this specification).

To the wet cake corresponding to 260 Kg as a dry solid content, 19.3 Kg of polyvinyl alcohol (trade name: PVA-217) and water were added to make a total amount of 1,000 Kg, and then the resulting mixture was made into a slurry by a dissolver blade and preliminarily dispersed by a pipeline mixer (Model PM-10 manufactured by Mizuho Kogyo).

Next, the preliminarily dispersed stock solution was treated three times in a dispersing machine (trade name: Microfluidizer M-610, manufactured by Microfluidex International Corporation, using a Z-type interaction chamber) under the control of pressure to 1,260 kg/cm² to obtain a silver behenate dispersion. At the dispersion, the temperature was set to 18° C. by a cooling operation of controlling the temperature of coolant using coiled heat exchangers attached to the inlet side and outlet side of the interaction chamber.

(Preparation of Reducing Agent Dispersion)

<Preparation of Reducing Agent Complex 1 Dispersion>

To 10 kg of Reducing Agent Complex 1 (a 1:1 complex of 6,6′-di-t-butyl-4,4′-dimethyl-2,2′-butylidenediphenol and triphenylphosphine oxide), 0.12 Kg of triphenylphosphine oxide, 16 Kg of a 10% by weight aqueous solution of modified polyvinyl alcohol (Poval MP203, produced by Kuraray Co., Ltd.), 10 Kg of water was added and thoroughly mixed to form a slurry. The slurry was transferred by a diaphragm pump and dispersed in a horizontal sandmill (UVM-2, manufactured by AIMEX K.K.) filled with zirconia beads having an average diameter of 0.5 mm for 4 hours and 30 minutes, and 0.2 g of benzoisothiazolinone sodium salt and water were added thereto to adjust the reducing agent concentration to 22% by weight, thereby obtaining Reducing Agent Complex 1 Dispersion. The reducing agent complex particles contained in the thus obtained reducing agent complex dispersion had a median diameter of 0.45 μm and a maximum particle size of 1.4 μm or less. The obtained reducing agent complex dispersion was filtered through a polypropylene-made filter having a pore size of 3.0 μm to remove foreign matters such as dust and then housed.

<Preparation of Reducing Agent 2 Dispersion>

To 10 kg of Reducing Agent 2 (6,6′-di-t-butyl-4,4′-dimethyl-2,2′-butylidenediphenol) and 16 Kg of a 10% by weight aqueous solution of modified polyvinyl alcohol (Poval MP203, produced by Kuraray Co., Ltd.), 10 Kg of water was added and thoroughly mixed to form a slurry. The slurry was transferred by a diaphragm pump and dispersed in a horizontal sand mill (UVM-2: manufactured by AIMEX K.K.) filled with zirconia beads having an average diameter of 0.5 mm for 3 hours and 30 minutes, and then 0.2 g of benzoisothiazolinone sodium salt and water were added thereto to adjust the reducing agent concentration to 25% by weight, thereby obtaining Reducing Agent 2 Dispersion. The reducing agent particles contained in the thus obtained reducing agent dispersion had a median diameter of 0.40 μm and a maximum particle size of 1.5 μm or less. The obtained reducing agent dispersion was filtered through a polypropylene-made filter having a pore size of 3.0 μm to remove foreign matters such as dust and then housed.

<Preparation of Hydrogen Bond-Forming Compound 1 Dispersion>

To 10 Kg of Hydrogen Bond-Forming Compound 1 (tri(4-tert-butylphenyl)phosphine oxide) and 16 Kg of a 10% by weight aqueous solution of modified polyvinyl alcohol (Poval MP203, produced by Kuraray Co., Ltd.), 10 Kg of water was added and thoroughly mixed to form a slurry. The resulting slurry was transferred by a diaphragm pump and dispersed in a horizontal sand mill (UVM-2, manufactured by AIMEX K.K.) filled with zirconia beads having an average diameter of 0.5 mm for 3 hours and 30 minutes, and then 0.2 g of benzoisothiazolinone sodium salt and water were added thereto to adjust the hydrogen bond-forming compound concentration to 25% by weight, thereby obtaining Hydrogen Bond-Forming Compound 1 Dispersion. The particles contained in the thus obtained dispersion had a median diameter of 0.35 μm and a maximum particle size of 1.5 μm or less. The obtained hydrogen bond-forming compound dispersion was filtered through a polypropylene-made filter having a pore size of 3.0 μm to remove foreign matters such as dust and then housed.

<Preparation of Development Accelerator 1 Dispersion>

To 10 Kg of Development Accelerator 1 and 20 Kg of a 10% by weight aqueous solution of modified polyvinyl alcohol (Poval MP203, produced by Kuraray Co., Ltd.), 10 Kg of water was added and thoroughly mixed to form a slurry. The resulting slurry was transferred by a diaphragm pump and dispersed in a horizontal sand mill (UVM-2, manufactured by AIMEX K.K.) filled with zirconia beads having an average diameter of 0.5 mm for 3 hours and 30 minutes, and then 0.2 g of benzoisothiazolinone sodium salt and water were added thereto to adjust the development accelerator concentration to 20% by weight, thereby obtaining Development Accelerator 1 Dispersion. The development accelerator 1 particles contained in the thus obtained development accelerator 1 dispersion had a median diameter of 0.48 μm and a maximum particle size of 1.4 μm or less. The obtained development accelerator 1 dispersion was filtered through a polypropylene-made filter having a pore size of 3.0 μm to remove foreign matters such as dust and then housed.

Each of Solid Dispersions of Development Accelerator 2, Development Accelerator 3 and Color Tone Adjuster 1 was obtained also as a 20% by weight dispersion in the same manner as Development Accelerator 1.

(Preparation of Polyhalogen Compound)

<Preparation of Organic Polyhalogen Compound 1 Dispersion>

To 10 Kg of Organic Polyhalogen Compound 1 (tribromomethanesulfonylbenzene), 10 Kg of a 20% by weight aqueous solution of modified polyvinyl alcohol (Poval MP203, produced by Kuraray Co., Ltd.) and 0.4 Kg of a 20% by weight aqueous solution of sodium triisopropylnaphthalenesulfonate, 14 Kg of water was added and thoroughly mixed to form a slurry. The resulting slurry was transferred by a diaphragm pump and dispersed in a horizontal sand mill (UVM-2, manufactured by AIMEX K.K.) filled with zirconia beads having an average diameter of 0.5 mm for 5 hours, and then 0.2 g of benzoisothiazolinone sodium salt and water were added thereto to adjust the organic polyhalogen compound concentration to 26% by weight, thereby obtaining Organic Polyhalogen Compound 1 Dispersion. The organic polyhalogen compound particles contained in the thus obtained organic polyhalogen compound dispersion had a median diameter of 0.41 μm and a maximum particle size of 2.0 μm or less. The obtained organic polyhalogen compound dispersion was filtered through a polypropylene-made filter having a pore size of 10.0 μm to remove foreign matters such as dust and then housed.

<Preparation of Organic Polyhalogen Compound 2 Dispersion>

To 10 Kg of Organic Polyhalogen Compound 2 (N-butyl-3-tribromomethanesulfonylbenzamide) and 20 Kg of a 10% by weight aqueous solution of modified polyvinyl alcohol (Poval MP203, produced by Kuraray Co., Ltd.), 0.4 Kg of a 20% by weight aqueous solution of sodium triisopropylnaphthalenesulfonate was added and thoroughly mixed to form a slurry. The resulting slurry was transferred by a diaphragm pump and dispersed in a horizontal sand mill (UVM-2, manufactured by AIMEX K.K.) filled with zirconia beads having an average diameter of 0.5 mm for 5 hours, and then 0.2 g of benzoisothiazolinone sodium salt and water were added thereto to adjust the organic polyhalogen compound concentration to 30% by weight. The dispersion solution was heated at 40° C. for 5hours to obtain Organic Polyhalogen Compound 2 Dispersion. The organic polyhalogen compound particles contained in the thus obtained polyhalogen compound dispersion had a median diameter of 0.40 μm and a maximum particle size of 1.3 μm or less. The obtained organic polyhalogen compound dispersion was filtered through a polypropylene-made filter having a pore size of 3.0 μm to remove foreign matters such as dust and then housed.

<Preparation of Formula (I) Compounds Solutions>(Kinds and Amounts Are Described in Table 1)

An 8 Kg of modified polyvinyl alcohol MP203 produced by Kuraray Co., Ltd. was dissolved in 174.57 Kg of water, and then 3.15 Kg of a 20% by weight aqueous solution of sodium triisopropylnaphthalenesulfonate and 10 Kg of a compound of formula (I) were added thereto to prepare a 5% by weight solution of a compound of general formula (I).

(Preparation of Mercapto Compound)

<Preparation of Aqueous Mercapto Compound 1 Solution>

A 7 g portion of Mercapto Compound 1 (1-(3-sulfophenyl)-5-mercaptotetrazole sodium salt) was dissolved in 993 g of water to prepare a 0.7% by weight aqueous solution.

<Preparation of Aqueous Mercapto Compound 2 Solution>

A 20 g portion of Mercapto Compound 2 (1-(3-methylureido)-5-mercaptotetrazole sodium salt) was dissolved in 980 g of water to prepare a 2.0% by weight aqueous solution.

<Preparation of Pigment 1 Dispersion>

To 64 g of C.I. Pigment Blue 60 and 6.4 g of Demol N produced by Kao Corporation, 250 g of water was added and thoroughly mixed to form a slurry. The resulting slurry and 800 g of zirconia beads having an average diameter of 0.5 mm were put together into a vessel and dispersed for 25 hours in a dispersing machine (¼G Sand Grinder Mill, manufactured by AIMEX K.K.) to obtain Pigment 1 Dispersion. The pigment particles contained in the thus obtained pigment dispersion had an average particle size of 0.21 μm.

<Preparation of SBR Latex Solution>

An SBR latex having a Tg value of 22° C. was prepared as follows.

Using ammonium persulfate as a polymerization initiator and an anionic surfactant as an emulsifier, 70.0 parts by weight of styrene, 27.0 parts by weight of butadiene and 3.0 parts by weight of acrylic acid were subjected to emulsion polymerization and then aging was carried out at 80° C. for 8 hours. Thereafter, the resulting solution was cooled to 40° C. and adjusted to a pH value of 7.0 with aqueous ammonia, and then SANDET BL produced by Sanyo Kasei K.K. was added to have a concentration of 0.22%. Chloride ion concentration in the SBR latex was adjusted to 300 ppm by adding a sodium chloride aqueous solution to the SANDET BL, and the chloride ion concentration was controlled by dialyzing the SBR latex (the chloride ion concentration was described in Table 1). Reduction of the chloride ion concentration was able to effect by increasing the dialysis frequency. Next, the pH was adjusted to 8.3 by adding an aqueous 5% sodium hydroxide solution and then, the pH was adjusted to 8.4 with aqueous ammonia. The molar ratio of Na⁺ ion and NH₄⁺ ion used here was 1:2.3. Thereafter, to 1 Kg of the solution, 0.15 ml of a 7% aqueous solution of benzoisothiazolinone sodium salt was added to prepare an SBR latex solution.

(SBR Latex: Latex of -St(70.0)-Bu(27.0)-AA(3.0)-) Tg 22° C.

Average particle size: 0.1 μm, concentration: 43% by weight, equilibrium moisture content at 25° C. and 60% RH: 0.6% by weight, ion conductivity: 4.2 mS/cm (in the measurement of ion conductivity, the latex stock solution (43% by weight) was measured at 25° C. using a conductivity meter CM-30S manufactured by Toa Denpa Kogyo K.K.), pH: 8.4.

SBR latexes different in the Tg can be prepared in the same manner by appropriately changing the ratio of styrene and butadiene.

<Preparation of Coating Solution 1 for Emulsion Layer (Photosensitive Layer)>

A 1,000 g portion of the fatty acid silver salt dispersion, 276 ml of water, 33.2 g of Pigment 1 Dispersion, 21 g of Organic Polyhalogen Compound 1 Dispersion, 58 g of Organic Polyhalogen Compound 2 Dispersion, solution of each compound of formula (I) (kinds and amounts are described in Table 1), 1,082 g of SBR latex (Tg: 22° C.) solution, 299 g of Reducing Agent Complex 1 Dispersion, 6 g of Development Accelerator 1 Dispersion, 9 ml of Aqueous Mercapto Compound 1 Solution and 27 ml of Aqueous Mercapto Compound 2 Solution were sequentially added, and immediately before the coating, 117 g of Silver Halide Mixed Emulsion A was added and thoroughly mixed. The resulting coating solution for emulsion layer was directly transferred to a coating die and coated.

The viscosity of the coating solution for emulsion layer obtained above was measured by a Brookfield viscometer manufactured by Tokyo Keiki Kogyo K.K. and found to be 25 [mPa·s] at 40° C. (No. 1 rotor, 60 rpm).

The viscosity of the coating solution measured at 25° C. using RFS Field Spectrometer manufactured by Rheometrics Far East K.K. was 235, 59, 47, 23 and 15 [mPa·s] at a shear rate of 0.1, 1, 10, 100 and 1,000 [1/sec], respectively.

The amount of zirconium in the coating solution was 0.25 mg per g of silver.

<Preparation of Coating Solution 2 for Emulsion Layer (Photosensitive Layer)>

The fatty acid silver salt dispersion prepared above (1,000 g), 276 ml of water, 32.8 g of Pigment 1 Dispersion, 21 g of Organic Polyhalogen Compound 1 Dispersion, 58 g of Organic Polyhalogen Compound 2 Dispersion, solution of each compound of formula (I) (kinds and amounts are described in Table 1), 1,082 g of SBR latex (Tg: 20° C.) solution, 155 g of Reducing Agent 2 Dispersion, 55 g of Hydrogen Bond-Forming Compound 1 Dispersion, 6 g of Development Accelerator 1 Dispersion, 2 g of Development Accelerator 2 Dispersion, 3 g of Development Accelerator 3 Dispersion, 2 g of Color Tone Adjuster 1 Dispersion and 6 ml of Aqueous Mercapto Compound 2 Solution were sequentially added, and immediately before the coating, 117 g of Silver Halide Mixed Emulsion A was added and thoroughly mixed, and then the resulting coating solution for emulsion layer was transferred directly to a coating die and coated.

The viscosity of the coating solution for emulsion layer obtained above was measured by a Brookfield viscometer manufactured by Tokyo Keiki Kogyo K.K. and found to be 32 [mPa·s] at 40° C. (No. 1 rotor, 60 rpm).

The viscosity of the coating solution measured at 25° C. using RFS Field Spectrometer manufactured by Rheometrics Far East K.K. was 535, 143, 95, 56 and 25 [mPa·s] at a shear rate of 0.1, 1, 10, 100 and 1,000 [1/sec], respectively.

The amount of zirconium in the coating solution was 0.31 mg per g of silver.

<Preparation of Coating Solution for Interlayer on Emulsion Surface>

A 27 ml portion of a 5% by weight aqueous solution of Aerosol OT (produced by American Cyanamide), 135 ml of a 20% by weight aqueous solution of diammonium phthalate and water for making a total amount of 10,000 g were added to 1,000 g of polyvinyl alcohol PVA-205 (produced by Kuraray Co., Ltd.), 272 g of a 5% by weight pigment dispersion and 4,200 ml of a 19% by mass solution of methyl methacrylate/styrene/butyl acrylate/hydroxyethyl methacrylate/acrylic acid copolymer (copolymerization weight ratio: 64/9/20/5/2) latex. The pH was adjusted to 7.5 with NaOH to prepare a coating solution for interlayer and then the coating solution was transferred to a coating die to give a coverage of 9.1 ml/m².

The viscosity of the coating solution was measured at 40° C. by a Brookfield viscometer (No. 1 rotor, 60 rpm) and found to be 58 [mPa·s].

<Preparation of Coating Solution for First Protective Layer on Emulsion Surface>

A 64 g portion of inert gelatin was dissolved in water, to which 80 g of a 27.5% by weight solution of methyl methacrylate/styrene/butyl acrylate/hydroxyethyl methacrylate/acrylic acid copolymer (copolymerization weight ratio: 64/9/20/5/2) latex, 23 ml of a 10% by weight methanol solution of phthalic acid, 23 ml of a 10% by weight aqueous solution of 4-methylphthalic acid, 28 ml of sulfuric acid in a concentration of 0.5 mol/L, 5 ml of a 5% by weight aqueous solution of Aerosol OT (produced by American Cyanamide), 0.5 g of phenoxyethanol, 0.1 g of benzoisothiazolinone and water for making a total amount of 750 g were subsequently added to prepare a coating solution. Immediately before the coating, 26 ml of a 4% by weight chrome alum was mixed therewith using a static mixer, the mixture was transferred to a coating die to give a coverage of 18.6 ml/m².

The viscosity of the coating solution measured by a Brookfield viscometer at 40° C. (No. 1 rotor, 60 rpm) was 20 [mPa·s].

<Preparation of Coating Solution for Second Protective Layer on Emulsion Surface>

An 80 g portion of inert gelatin was dissolved in water, to which were subsequently added 102 g of a 27.5% by weight solution of methyl methacrylate/styrene/butyl acrylate/hydroxyethyl methacrylate/acrylic acid copolymer (copolymerization weight ratio: 64/9/20/5/2) latex, 3.2 ml of a 5% by weight solution of Fluorine-Containing Surfactant (F-1: N-perfluorooctylsulfonyl-N-propylalanine potassium salt), 32 ml of a 2% by weight aqueous solution of Fluorine-Containing Surfactant (F-2: polyethylene glycol mono(N-perfluorooctylsulfonyl-N-propyl-2-aminoethyl) ether [ethylene oxide average polymerization degree=15]), 23 ml of a 5% by weight solution of Aerosol OT (produced by American Cyanamide), 4 g of polymethyl methacrylate fine particles (average particle size: 0.7 μm), 21 g of polymethylmethacrylate fine particles (average particle size: 4.5 μm), 1.6 g of 4-methylphthalic acid, 4.8 g of phthalic acid, 44 ml of sulfuric acid in a concentration of 0.5 mol/L, 10 mg of benzoisothiazolinone and water for making a total amount of 650 g. Immediately before the coating, 445 ml of an aqueous solution containing 4% by weight of chrome alum and 0.67% by weight of phthalic acid was mixed therewith using a static mixer to obtain a coating solution for surface protective layer and then the coating solution was transferred to a coating die to give a coverage of 8.3 ml/m².

The viscosity of the coating solution measured at 40° C. by a Brookfield viscometer (No. 1 rotor, 60 rpm) was 19 [mPa·s].

<Preparation of Heat-Developable Photosensitive Material 1>

On the back surface side of the undercoated support, the coating solution for antihalation layer and the coating solution for back surface protective layer were simultaneously coated one on another to give a coated amount of solid fine particle dye of 0.04 g/m² as a solid content and a gelatin coated amount of 1.7 g/m², respectively, and then the coating was dried to form a back layer.

On the surface opposite the back surface, an emulsion layer, an interlayer, a first protective layer and a second protective layer were simultaneously coated one on another in this order from the undercoated surface by a slide bead coating method to prepare a heat-developable photosensitive material sample. At this time, the temperature was adjusted such that the emulsion layer and the interlayer were 31° C., the first protective layer was 36° C. and the second protective layer was 37° C.

The coated amount (g/m²) of each compound in the emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |

Compound of formula (I) (kinds and amounts are described in Table 1)

| | |
|---|---|
| SBR Latex | 9.97 |
| Reducing Agent Complex 1 | 1.41 |
| Development Accelerator 1 | 0.024 |
| Mercapto Compound 1 | 0.002 |
| Mercapto Compound 2 | 0.012 |
| Silver Halide (as Ag) | 0.091 |

The coating and drying conditions were as follows.

The coating was performed at a speed of 160 m/min, the distance between the tip of coating die and the support was set to from 0.10 to 0.30 mm, and the pressure in the vacuum chamber was set lower by 196 to 882 Pa than the atmospheric pressure. The support was destaticized by ionized wind before the coating.

In the subsequent chilling zone, the coating solution was cooled with air showing a dry bulb temperature of 10 to 20° C. The sample was then subjected to contact-free transportation, and in a helical floating-type dryer, dried with drying air showing a dry bulb temperature of 23 to 45° C. and a wet bulb temperature of 15 to 21° C.

After drying, the humidity was adjusted to 40 to 60% RH at 25° C. and then, the layer surface was heated to 70 to 90° C. The heated layer surface was then cooled to 25° C.

The heat-developable photosensitive material thus prepared had a matting degree of, in terms of the Bekk smoothness, 550 seconds on the photosensitive layer surface and 130 seconds on the back surface. Furthermore, the pH on the layer surface on the photosensitive layer side was measured and found to be 6.0.

<Preparation of Heat-Developable Photosensitive Material 2>

Heat-Developable Photosensitive Material 2 was prepared in the same manner as Heat-Developable Photosensitive Material 1 except that in the preparation of Heat-Developable Photosensitive Material 1, Coating Solution 1 for Emulsion Layer was changed to Coating Solution 2 for Emulsion Layer, Yellow Dye Compound 1 was eliminated from the antihalation layer, and the fluorine-containing surfactants in the back surface protective layer and emulsion surface protective layer were changed from F-1, F-2, F-3 and F-4 to F-5, F-6, F-7 and F-8, respectively.

The coated amount (g/m²) of each compound in the emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |

Compound of formula (I) (kinds and amounts are described in Table 1)

| | |
|---|---|
| SBR Latex | 9.67 |
| Reducing Agent 2 | 0.81 |
| Hydrogen Bond-Forming Compound 1 | 0.30 |
| Development Accelerator 1 | 0.024 |
| Development Accelerator 2 | 0.010 |
| Development Accelerator 3 | 0.015 |
| Color Tone Adjuster 1 | 0.010 |
| Mercapto Compound 2 | 0.002 |
| Silver Halide (as Ag) | 0.091 |

Chemical structures of the compounds used in Examples of the invention are shown below.

Structures of Comparative Compounds C-1 and C-2 for the compounds of the formula (I) are also shown below. The dispersions thereof were prepared in the same manner as the dispersions of the compounds of formula (I). The kinds and amounts thereof are described in Table 1.

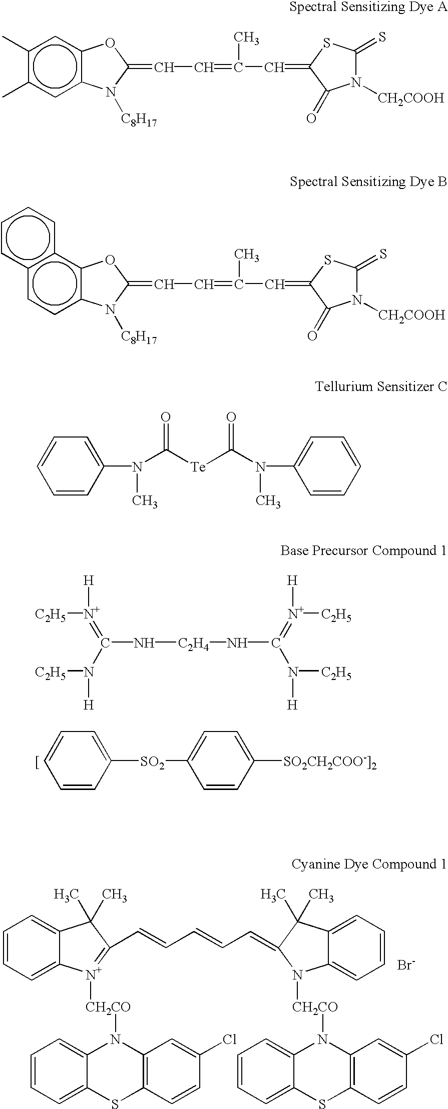

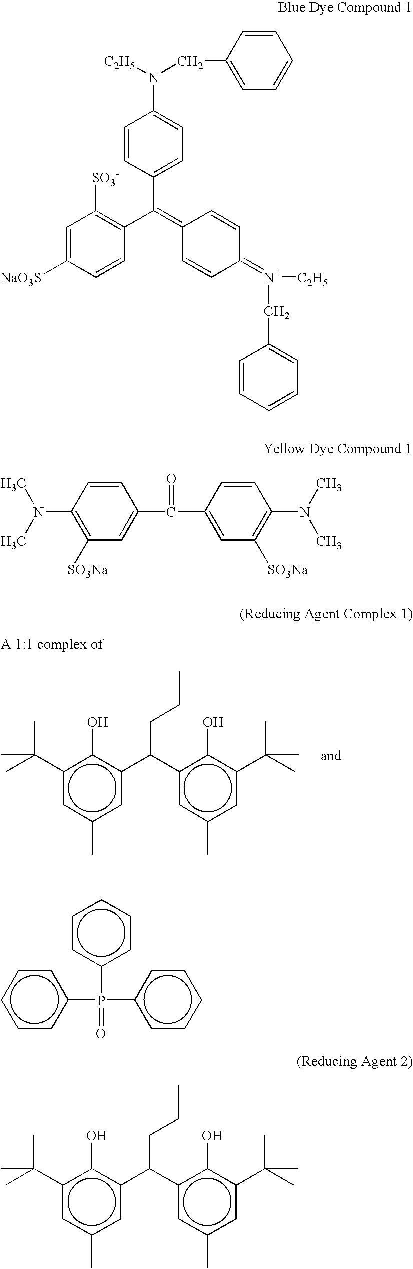

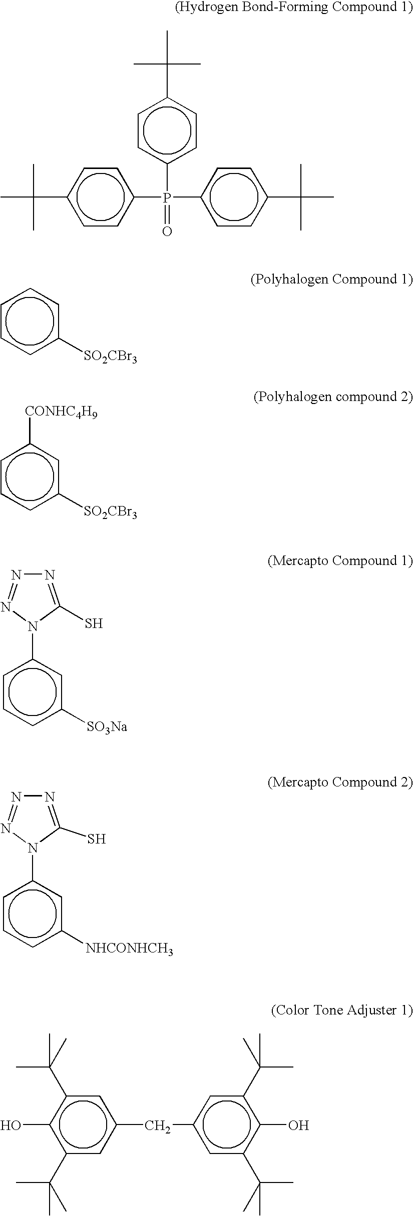

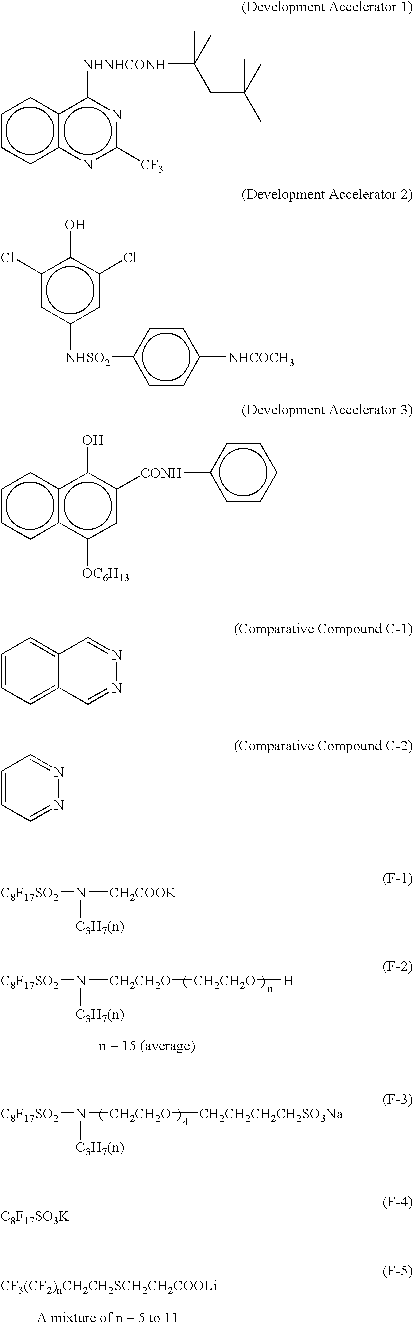

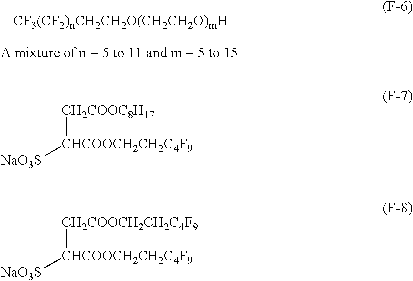

(Evaluation of Photographic Performance)

Each of the obtained samples was cut into a size of 356×432 mm, wrapped with the following packaging material in the environment of 25° C. and 50% RH, stored at an ordinary temperature for 1 week and then evaluated on the items shown below.

(Packaging Material)

A laminate of 10 μm of PET/12 μm of PE/9 μm of aluminum foil/15 μm of Ny/50 μm of polyethylene containing 3% of carbon black;

Oxygen permeability: 0 ml/atm·m²·25° C.·day

Moisture permeability: 0 g/atm·m²·25° C.·day

The samples each was exposed and heat-developed by Fuji Medical Dry Laser Imager FM-DP L (equipped with a semiconductor laser of 660 nm having a maximum output of 60 mW (IIIB) and four sheets of panel heater set at 112° C.-119° C.-121° C.-121° C.). The heat-development times were 24 seconds in total in the case of the heat-developable photosensitive material 1 and 14 seconds in total in the case of the heat-developable photosensitive material 2). The evaluation was carried out using a densitometer.

(Evaluation of Image Preservability)

Each sample was stored under an environment of 40° C. and 50% RH under a light shielding condition for 1 or 3 weeks and then the image color tone was evaluated. The evaluation was carried out visually, and ◯ or more is practically necessary.

◯◯: Neutral tone in all density ranges.

◯: Slightly reddish, yellowish or brownish in density of around 0.3.

Δ: Slightly reddish, yellowish or brownish in density of around 1.0.

X: Slightly reddish, yellowish or brownish in density of around 3.0.

TABLE 1

| | | | | | Chloride ion | | | | | | |
|---|---|---|---|---|---|---|---|---|---|---|---|
| | | Compound of | | | concentration | | | | | | |
| | | formula (I) | | | in SBR | based on | Photographic | | Image | | |
| | Heat-developable | | | Melting | latex | organic | property after | | preservability | | |
| Exp. | photosensitive | | Amount | point | solution | silver | heat development | | 40° C., | 40° C., | |
| No. | material (Note 1) | Kind | (mol/m²) | (° C.) | (ppm) | salt (ppm) | (Dmin) | (Dmax) | 1 week | 3 weeks | Remarks |
| 1 | 1 | C-1 | 1 × 10⁻³ | 89 | 140 | 570 | 0.15 | 3.8 | Δ | X | Comp. Ex. |
| 2 | 1 | C-2 | 1 × 10⁻³ | −8 | 140 | 570 | 0.15 | 3.2 | X | X | Comp. Ex. |
| 3 | 1 | I-12 | 1 × 10⁻³ | 123 | 140 | 570 | 0.15 | 3.8 | ◯◯ | ◯ | Invention |
| 4 | 1 | I-7 | 1 × 10⁻³ | 55 | 300 | 1220 | 0.15 | 4.0 | Δ | X | Comp. Ex. |
| 5 | 1 | I-7 | 1 × 10⁻³ | 55 | 140 | 570 | 0.15 | 4.0 | ◯◯ | ◯ | Invention |
| 6 | 1 | I-7 | 1 × 10⁻³ | 55 | 50 | 200 | 0.15 | 4.0 | ◯◯ | ◯◯ | Invention (preferred) |
| 7 | 1 | I-7 | 1 × 10⁻³ | 55 | 10 | 40 | 0.15 | 4.0 | ◯◯ | ◯◯ | Invention (preferred) |
| 8 | 2 | C-1 | 1 × 10⁻³ | 89 | 10 | 40 | 0.15 | 3.9 | Δ | X | Comp. Ex. |
| 9 | 2 | I-7 | 1 × 10⁻³ | 55 | 300 | 1220 | 0.15 | 3.2 | Δ | X | Comp. Ex. |
| 10 | 2 | I-12 | 1 × 10⁻³ | 123 | 10 | 40 | 0.15 | 4.1 | ◯◯ | ◯◯ | Invention (preferred) |
| 11 | 2 | I-7 | 1 × 10⁻³ | 55 | 10 | 40 | 0.15 | 4.1 | ◯◯ | ◯◯ | Invention (preferred) |
| 13 | 1 (reducing agent = | I-7 | 1 × 10⁻³ | 55 | 140 | 570 | 0.15 | 4.0 | ◯◯ | ◯ | Invention |
| | 1 − 1) | | | | | | | | | | |
| 14 | 1 (reducing agent = | I-12 | 1 × 10⁻³ | 123 | 140 | 570 | 0.15 | 4.0 | ◯◯ | ◯ | Invention |
| | 1 − 1) | | | | | | | | | | |

(Note 1):
The “reducing agent = 1 − 1” of Experiment Nos. 13 and 14 are samples prepared by dispersing the same mol of the reducing agent 1 − 1 in the same manner instead of the reducing agent complex of heat-developable photosensitive material 1.

It is apparent from Table 1 that the heat-developable photosensitive material of the invention has high Dmax and low Dmin and is excellent in the color tone of heat-developed image after storage in the dark.

### EXAMPLE 2

<Preparation of Silver Halide Grains>

A solution was prepared by dissolving 22 g of phthalated gelatin and 30 mg of potassium bromide in 700 ml of water and adjusted to pH 5.0 at 35° C., to which were subsequently added 159 ml of an aqueous solution containing 18.6 g of silver nitrate and 0.9 g of ammonium nitrate and an aqueous solution containing potassium bromide and potassium iodide at a molar ratio of 92:8, over a period of 10 minutes by a controlled double jet method while maintaining the pAg at 7.7. Next, 476 ml of an aqueous solution containing 55.4 g of silver nitrate and 2 g of ammonium nitrate and an aqueous solution containing 10 μmol/liter of potassium hexachloroiridate(II) and 1 mol/liter of potassium bromide were added thereto over a period of 30 minutes by a controlled double jet method while maintaining the pAg at 7.7. Next, 1 g of 4-hydroxy-6-methyl-1,3,3a,7-tetrazaindene was added thereto and the pH was further lowered to cause aggregation precipitation, thereby carrying out desalting treatment. Thereafter, 0.1 g of phenoxyethanol was added thereto, and the mixture was adjusted to pH 5.9 and pAg 8.2 to complete the preparation of silver iodobromide grains (cubic grains having an iodine content of the core portion of 8% by mol, an average iodine content of 2% by mol, an average size of 0.05 μm, a coefficient of variation in projected area of 8% and a [100] face ratio of 88%).

The thus obtained silver halide grains were heated to 60° C., mixed with 85 μmol of sodium thiosulfate, 11 μmol of 2,3,4,5,6-pentafluorophenyldiphenylphosphine selenide, 15 μmol of Tellurium Compound A, 3.4 μmol of chloroauric acid and 200 μmol of thiocyanic acid, per 1 mol silver, subjected to 120 minutes of ripening, and then rapidly cooled to 30° C. to obtain a silver halide emulsion.

<Preparation of Organic Acid Silver Salt Emulsion>

While vigorously stirring 7 g of stearic acid, 4 g of arachidinic acid, 36 g of behenic acid and 850 ml of distilled water at 90° C., 187 ml of 1 N NaOH aqueous solution was added thereto and allowed to undergo the reaction for 60 minutes, 65 ml of 1 N nitric acid was added thereto and then the temperature was reduced to 50° C. Next, while further vigorously stirring, 0.6 g of N-bromosuccinimide was added thereto and, 10 minutes thereafter, the silver halide grains prepared above were added thereto to a silver halide concentration of 6.2 mmol. Further, 125 ml of aqueous solution containing 21 g of silver nitrate was added over a period of 100 seconds, the mixture was stirred for 10 minutes as such, and then 0.6 g of N-bromosuccinimide was added thereto and allowed to stand for 10 minutes. Thereafter, the solid matter was collected by suction filtration and washed with water until conductivity of the filtrate became 30 μS/cm. A 150 g portion of butyl acetate solution containing 0.6% by weight of polyvinyl acetate was added to the thus obtained solid matter and stirred, the mixture was separated to an oil layer and a water layer by stopping the stirring and allowing to stand, and then the oil layer was obtained by removing the water layer together with the salts contained therein. Next, 80 g of 2-butanone solution containing 2.5% by weight of polyvinyl butyral (Denka Butyral #3000-K, manufactured by Denki Kagaku Kogyo) was added to the oil layer and stirred. Further, 0.1 mmol of pyridinium tribromide and 0.1 mmol of calcium bromide dihydrate were added thereto together with 0.7 g of methanol, and then 200 g of 2-butanone and 59 g of polyvinyl butyral (BUTVAR™ manufactured by Monsanto Co.; a sample of 2-butanone solution of polyvinyl butyral was prepared by removing chloride ions by washing the solution with water, and the chloride ion concentration of polyvinyl butyral was controlled by mixing a usual sample with the chloride ion-removed sample at a desired ratio, wherein the concentration was adjusted as described in Table 2) were added thereto and dispersed using a homogenizer to obtain an organic acid silver salt emulsion (needle particles having an average minor axis of 0.04 μm, an average major axis of 1 μm and a coefficient of variation of 30%).

<Preparation of Coating Solution for Emulsion Layer>

Each component was added to the thus obtained organic acid silver salt emulsion, in the following amount per 1 mol silver. At 25° C., 10 mg of sodium phenylthiosulfonate, 80 mg of Sensitizing Dye A, 2 g of 2-mercapto-5-methylbenzimidazole, 12 g of 4-chlorobenzophenone-2-carboxylic acid and 10 g of monobutyl phthalate were added to 580 g of 2-butanone and 220 g of dimethylformamide while stirring. Next, 3 g of 5-tribromomethylsulfonyl-2-methylthiadiazole, 3 g of tribromomethylnaphthylsulfone, 6 g of tribromomethylphenylsulfone, 5 g of 4,6-ditrichloromethyl-2-phenyltriazine, 2 g of Disulfide Compound, 50 g of 1,1-bis(2-hydroxy-3,5-dimethylphenyl)-2-methylpropane, 100 g of 1,1-bis(2-hydroxy-3,5-dimethylphenyl)-3,5,5-trimethylhexane, 12 g of Dye A, 1.1 g of Megafac F-176P (a fluorine-based surfactant manufactured by Dainippon Ink & Chemicals, Inc.), 590 g of methyl ethyl ketone (MEK) and 10 g of methyl isobutyl ketone (MIBK) were added while stirring, thereby obtaining a coating solution for emulsion layer.

<Preparation of Coating Solution for Protecting Layer on Emulsion Surface>

A solution was prepared by dissolving 75 g of CAB171-15S (cellulose acetate butyrate manufactured by Eastman Chemical), 5.7 g of 4-methylphthalic acid, 1.5 g of tetrachlorophthalic anhydride, the compound of formula (I) (kinds and amounts are described in Table 2), 5.1 g of tetrachlorophthalic acid, 0.3 g of Megafac F-176P, 2 g of Sildex H31 (spherical silica having an average size of 3 μm, manufactured by Dokai Kagaku) and 7 g of Sumidur N3500 (polyisocyanate, manufactured by Sumitomo Bayer Urethane) in 3,070 g of MEK and 30 g of ethyl acetate.

<Coating of Back Surface>

A 6 g portion of polyvinyl butyral (Denka Butyral #4000-2, manufactured by Denki Kagaku Kogyo), 0.2 g of Sildex H121 (spherical silica having an average size of 12 μm, manufactured by Dokai Kagaku), 0.2 g of Sildex H51 (spherical silica having an average size of 5 μm, manufactured by Dokai Kagaku) and 0.1 g of Megafac F-176P were added to 64 g of 2-propanol while stirring to effect their dissolution and mixing. Further, a mixed solution of 10 g methanol and 20 g acetone containing 420 mg of Dye A and a solution of 7 g ethyl acetate containing 1 g of 3-isocyanatomethyl-3,5,5-trimethylhexyl isocyanate were added thereto to prepare a coating solution.

The coating solution for back surface was coated on a polyethylene terephthalate film in which both surfaces were composed of vinylidene-containing moisture-proof undercoats, to an optical density of 0.4 at 810 nm. Smoothness of the back surface (Bekk smoothness was examined using the Ohken system smoothness measurement described in J. TAPPI Paper Pulp Test Method No. 5) was 80 seconds.

<Preparation of Photosensitive Material>

The emulsion layer and protecting layer on emulsion surface were coated on the 175 μm polyethylene terephthalate support whose back surface had been coated in advance, in such amounts that the coating solution for emulsion layer resulted in the silver content of 2.1 g/m², and the coating solution for protecting layer on emulsion surface became a dry thickness of 1.8 μm on the emulsion surface. Also, when the amount of residual solvents in the emulsion layer-coated surface of coated samples was measured by a gas chromatography, from 40 to 200 ppm of MEK, from 10 to 100 ppm of MIBK and from 40 to 120 ppm of butyl acetate were detected on the coated material weight basis.

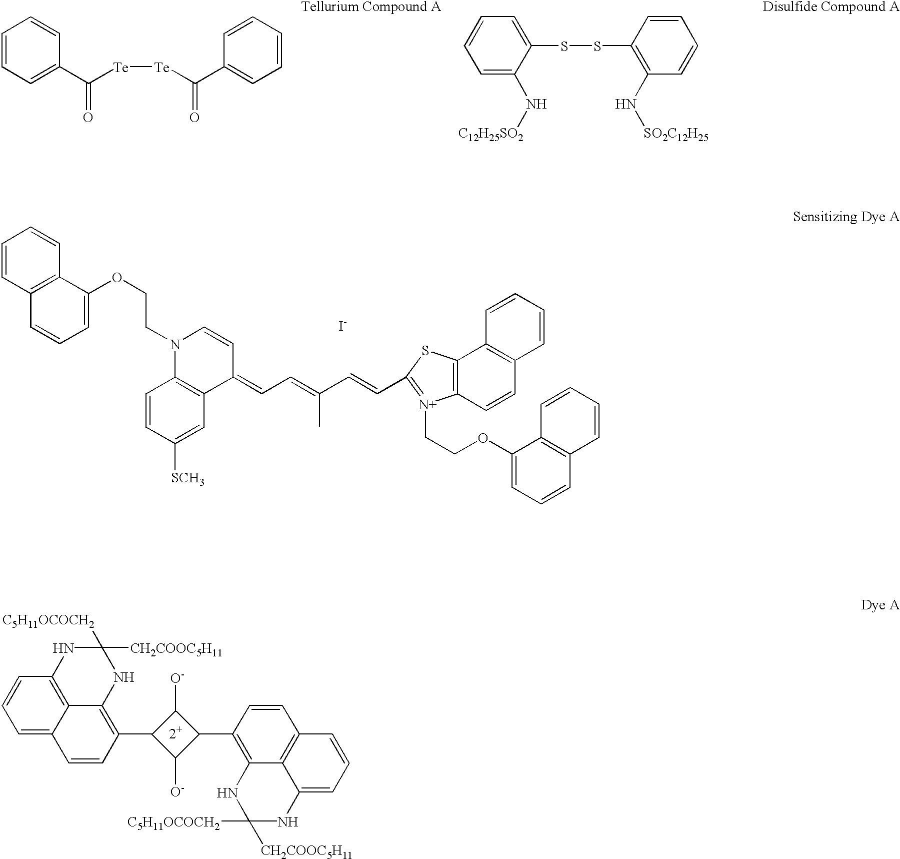

(Evaluation of Photographic Performance)

Each photographic material was exposed using a laser sensitometer equipped with an 810 nm diode and then treated (developed) at 120° C. for 15 seconds.

(Evaluation of Image Shelf Life)

The same evaluation as in Example 1 was carried out.

TABLE 2

| | Compound of | | | | | | | | | |
|---|---|---|---|---|---|---|---|---|---|---|
| | formula (I) | | | in | based on | Photographic | | Image | | |
| | | | Melting | polyvinyl | organic | property after | | preservability | | |
| Exp. | | Amount | point | butyral | silver salt | heat development | | 40° C., | 40° C., | |
| No. | Kind | (mol/m²) | (° C.) | (ppm) | (ppm) | (Dmin) | (Dmax) | 1 week | 3 weeks | Remarks |
| 1 | C-1 | 8 × 10⁻⁴ | 89 | 100 | 98 | 0.18 | 3.8 | Δ | X | Comp. Ex. |
| 2 | I-12 | 8 × 10⁻⁴ | 123 | 40 | 39 | 0.18 | 4.1 | ◯◯ | ◯◯ | Invention (preferred) |
| 3 | I-7 | 8 × 10⁻⁴ | 55 | 100 | 98 | 0.18 | 4.1 | ◯◯ | ◯ | Invention |
| 4 | I-7 | 8 × 10⁻⁴ | 55 | 15 | 14 | 0.18 | 4.1 | ◯◯ | ◯◯ | Invention (preferred) |
| 5 | I-7 | 8 × 10⁻⁴ | 55 | 670 | 650 | 0.18 | 4.1 | Δ | X | Comp. Ex. |

The effects similar to those in Example 1 were obtained by the invention.

According to the invention, a heat-developable photosensitive material which can give practically sufficient density, is low in fog and has excellent preservability after heat development can be provided.

The entire disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

What is claimed is:

1. A heat-developable photosensitive material comprising a support provided on one side thereof at least (1) a photosensitive layer containing a photosensitive silver halide, (2) a non-photosensitive organic silver salt, (3) a reducing agent and (4) a binder, wherein chloride ion concentration in all layers positioned on the photosensitive layer side of the support is 600 ppm or less based on the weight of the organic silver salt, and the heat-developable photosensitive material contains a compound represented by the following formula (I): 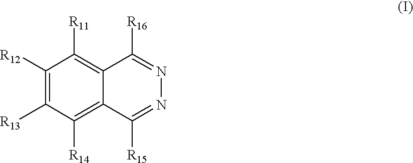
wherein, R₁₁, R₁₂, R₁₃, R₁₄, R₁₅ and R₁₆ each independently represent a hydrogen atom or a monovalent substituent group, or R₁₁, R₁₂, R₁₃, R₁₄, R₁₅ and R₁₆ may be combined with each other to form a ring, provided that all of R₁₁ to R₁₆ are not hydrogen atoms.

2. The heat-developable photosensitive material according to claim 1, wherein the photosensitive layer is one formed by applying an aqueous solution containing polymer latex in an amount of from 60% by weight to 100% by weight based on the amount of a binder of the photosensitive layer and drying.

3. The heat-developable photosensitive material according to claim 1, wherein the photosensitive layer is one formed by applying an organic solvent solution containing polyvinyl butyral in an amount of from 60% by weight to 100% by weight based on the amount of a binder of the photosensitive layer and drying.

4. The heat-developable photosensitive material according to claim 2, wherein chloride ion concentration in the polymer latex solution is 100 ppm or less.

5. The heat-developable photosensitive material according to claim 3, wherein chloride ion concentration in the polyvinyl butyral is 50 ppm or less.

6. The heat-developable photosensitive material according to claim 1, wherein a melting point of the compound represented by formula (I) is from −20° C. to 130° C.

7. The heat-developable photosensitive material according to claim 2, wherein a melting point of the compound represented by formula (I) is from −20° C. to 130° C.

8. The heat-developable photosensitive material according to claim 3, wherein a melting point of the compound represented by formula (I) is from −20° C. to 130° C.

9. The heat-developable photosensitive material according to claim 4, wherein a melting point of the compound represented by formula (I) is from −20° C. to 130° C.

10. The heat-developable photosensitive material according to claim 5, wherein a melting point of the compound represented by formula (I) is from −20° C. to 130° C.
